(19) United States
(12) Patent Application Publication
(10) Pub. No.: US 2025/0219226 A1
(43) Pub. Date: Jul. 3, 2025

(54) ELECTRICAL DEVICE AND CARRYING CASE

(71) Applicant: MAKITA CORPORATION, Anjo-shi (JP)

(72) Inventor: Junya Yamaguchi, Anjo-shi (JP)

(73) Assignee: MAKITA CORPORATION, Anjo-shi (JP)

(21) Appl. No.: 18/985,255

(22) Filed: Dec. 18, 2024

(30) Foreign Application Priority Data
Dec. 27, 2023 (JP) 2023-221783

(51) Int. Cl. H01M 50/256; H01M 50/209; H01M 50/247; H01M 50/271; H01M 50/296

(52) U.S. Cl. CPC H01M 50/256; H01M 50/209; H01M 50/247; H01M 50/271; H01M 50/296; H01M 2220/30

(57) ABSTRACT

An electrical device may include a case body, a battery receptacle configured to have a battery pack attached thereto, an external terminal configured to be electrically connected to the battery pack via the battery receptacle, a left handle disposed on a left surface of the case body and comprising a left grip configured to be grasped by a user, and a right handle disposed on a right surface of the case body and comprising a right grip configured to be grasped by the user. The left handle may be configured to be movable relative to the case body between a left lower position and a left upper position. The right handle may be configured to be movable relative to the case body between a right lower position and a right upper position.

### REFERENCE TO RELATED APPLICATION

This application claims priority to Japanese Patent Application No. 2023-221783 filed on Dec. 27, 2023. The entire content of the priority application is incorporated herein by reference.

### TECHNICAL FIELD

Disclosure herein relates to electrical devices and carrying cases.

### BACKGROUND ART

Chinese Patent Application Publication No. 115157197 describes a carrying case including a case body defining a housing space; a left handle disposed on a left surface of the case body and including a left grip configured to be grasped by a user; and a right handle disposed on a right surface of the case body and including a right grip configured to be grasped by the user. The positions of the left and right handles are fixed relative to the case body.

### SUMMARY

The carrying case described in Chinese Patent Application Publication No. 115157197 may further include a battery receptacle to which a battery pack is detachably attached and an external terminal configured to be electrically connected to the battery pack via the battery receptacle, so that the carrying case can function, for example, as an electrical device capable of charging and discharging the battery pack. However, the user of this electrical device may find the left handle and/or the right handle inconvenient since their positions relative to the case body are fixed. The disclosure herein provides technologies that allow for improvement in convenience of electrical devices.

An electrical device disclosed herein may comprise a case body defining a housing space, a battery receptacle disposed on the case body, wherein a battery pack used as a power supply for a power tool is attached to the battery receptacle, an external terminal disposed on the case body and configured to be electrically connected to the battery pack via the battery receptacle, a left handle disposed on a left surface of the case body and comprising a left grip configured to be grasped by a user, and a right handle disposed on a right surface of the case body and comprising a right grip configured to be grasped by the user. The left handle may be configured to be movable relative to the case body between a left lower position and a left upper position. A position of the left grip when the left handle is in the left upper position may be higher than a position of the left grip when the left handle is in the left lower position. The right handle may be configured to be movable relative to the case body between a right lower position and a right upper position. A position of the right grip when the right handle is in the right upper position may be higher than a position of the right grip when the right handle is in the right lower position.

When the left grip (the right grip) is positioned relatively high relative to the case body, the user can stably carry the electrical device grasping the left grip (the right grip) because the center of gravity of the electrical device is low. When the left grip (the right grip) is positioned relatively high relative to the case body, however, the left grip (the right grip) may stand in the way for the user to remove/put an object from/into the housing space. According to the configuration above, the user can change the position of the left grip (the right grip) relative to the case body in an up-down direction. For example, when the user is about to carry the electrical device, the user can move the left grip (the right grip) relative to the case body to a relatively high position, so that the user can stably carry the electrical device. Further, when the user is about to remove/put an object from/into the housing space, the user can move the left grip (the right grip) relative to the case body to a relatively low position, so that the left grip (the right grip) does not stand in the way for the user's action. Thus, the configuration above improves the convenience of the electrical device.

A carrying case disclosed herein may be configured to allow a user to carry at least one of a manual tool, a power tool, and a battery pack used as a power supply for a power tool. The carrying case may comprise a case body defining a housing space, a left handle disposed on a left surface of the case body and comprising a left grip configured to be grasped by the user, and a right handle disposed on a right surface of the case body and comprising a right grip configured to be grasped by the user. The left handle may be configured to be rotatable relative to the case body about a left handle rotation axis between a left lower position and a left upper position. A position of the left grip when the left handle is in the left upper position may be higher than a position of the left grip when the left handle is in the left lower position. When the left handle is in the left lower position, an upper end of the left grip may be positioned below the left handle rotation axis. When the left handle is in the left upper position, a lower end of the left grip may be positioned above the left handle rotation axis. The right handle may be configured to be rotatable relative to the case body about a right handle rotation axis between a right lower position and a right upper position. A position of the right grip when the right handle is in the right upper position may be higher than a position of the right grip when the right handle is in the right lower position. When the right handle is in the right lower position, an upper end of the right grip may be positioned below the right handle rotation axis. When the right handle is in the right upper position, a lower end of the right grip may be positioned above the right handle rotation axis.

When the left grip (the right grip) is positioned relatively high relative to the case body, the user can stably carry the carrying case grasping the left grip (the right grip) because the center of gravity of the carrying case is low. When the left grip (the right grip) is positioned relatively high relative to the case body, however, the left grip (the right grip) may stand in the way for the user to remove/put an object from/into the housing space. According to the configuration above, the user can change the position of the left grip (the right grip) relative to the case body in an up-down direction. For example, when the user is about to carry the carrying case, the user can move the left grip (the right grip) relative to the case body to a relatively high position, so that the user can stably carry the carrying case. Further, when the user is about to remove/put an object from/into the housing space, the user can move the left grip (the right grip) relative to the case body to a relatively low position, so that the left grip (the right grip) does not stand in the way for the user's action. Thus, the configuration above improves the convenience of the carrying case. Further, in the configuration above, the upper end of the left grip (the right grip) can be moved above the left handle rotation axis (the right handle rotation axis), which allows the center of gravity of the electrical device to be positioned sufficiently low when the user carries it. Thus, the user can stably carry the electrical device.

### BRIEF DESCRIPTION OF DRAWINGS

FIG. 1 shows a charger 2 according to a first embodiment as viewed from the upper rear left side, where a lid 6 is in an open position.

FIG. 2 shows the charger 2 according to the first embodiment as viewed from the upper rear left side, where the lid 6 is in a closed position.

FIG. 3 shows a configuration of a tray member 10 of the charger 2 according to the first embodiment.

FIG. 4 shows a cross-sectional view illustrating the internal structure of the charger 2 according to the first embodiment.

FIG. 5 shows the charger 2 according to the first embodiment as viewed from the lower front right side, where the lid 6 is in the closed position.

FIG. 6 shows a configuration of a coupling mechanism 34 of the charger 2 according to the first embodiment.

FIG. 7 shows how a first coupling member 36 and a second coupling member 38 of the coupling mechanism 34 according to the first embodiment are removed.

FIG. 8 shows another diagram illustrating how the first coupling member 36 and the second coupling member 38 of the coupling mechanism 34 according to the first embodiment are removed.

FIG. 9 shows still another diagram illustrating how the first coupling member 36 and the second coupling member 38 of the coupling mechanism 34 according to the first embodiment are removed.

FIG. 10 shows the charger 2 according to the first embodiment with the lid 6 removed therefrom, where the charger 2 is placed on a placement surface P in a different orientation from the orientation shown in FIGS. 1 and 2.

FIG. 11 shows the charger 2 according to the first embodiment with the lid 6 removed therefrom, where the charger 2 is placed on the placement surface P in a different orientation from the orientations shown in FIGS. 1, 2, and 10.

FIG. 12 shows the lid 6 and a sealing member 110 according to the first embodiment as viewed from the lower front left side.

FIG. 13 shows the charger 2 according to the first embodiment as viewed from the upper rear left side, where a clear surface 112 and a textured surface 114 of the lid 6 are schematically visualized.

FIG. 14 shows a top view of the charger 2 according to the first embodiment, where the clear surface 112 and the textured surface 114 of the lid 6 are schematically visualized.

FIG. 15 shows the charger 2 according to the first embodiment as viewed from the lower front right side, where the clear surface 112 and the textured surface 114 of the lid 6 are schematically visualized.

FIG. 16 shows a front view of the charger 2 according to the first embodiment, where a left handle 124 is in a left lower position and a right handle 136 is in a right lower position.

FIG. 17 shows a front view of the charger 2 according to the first embodiment, where the left handle 124 is in a left upper position and the right handle 136 is in a right upper position.

FIG. 18 shows the charger 2 according to the first embodiment as viewed from the upper front left side, where a case body 4 is placed on the lid 6 and an engagement member 162 is in engagement with an engagement receiver 164.

FIG. 19 shows the engagement member 162 according to the first embodiment as viewed from the upper rear right side.

FIG. 20 shows the charger 2 according to the first embodiment, where the engagement member 162 is about to engage with the engagement receiver 164.

FIG. 21 shows a configuration of a tray member 204 of a charger 202 according to a second embodiment.

### DESCRIPTION

Representative, non-limiting examples of the present disclosure will now be described in further detail with reference to the attached drawings. This detailed description is merely intended to teach a person of skill in the art further details for practicing aspects of the present teachings and is not intended to limit the scope of the present disclosure. Furthermore, each of the additional features and teachings disclosed below may be utilized separately or in conjunction with other features and teachings to provide improved electrical devices and carrying cases as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

In one or more embodiments, the left handle may be configured to be rotatable relative to the case body about a left handle rotation axis between the left lower position and the left upper position. When the left handle is in the left lower position, an upper end of the left grip may be positioned below the left handle rotation axis. When the left handle is in the left upper position, a lower end of the left grip may be positioned above the left handle rotation axis. The right handle may be configured to be rotatable relative to the case body about a right handle rotation axis between the right lower position and the right upper position. When the right handle is in the right lower position, an upper end of the right grip may be positioned below the right handle rotation axis. When the right handle is in the right upper position, a lower end of the right grip may be positioned above the right handle rotation axis.

If the upper end of the left grip (the right grip) cannot be moved above the left handle rotation axis (the right handle rotation axis), the center of gravity of the electrical device may not be sufficiently lowered when the user carries the electrical device, which may hinder the user from stably carrying the electrical device. According to the configuration above, the upper end of the left grip (the right grip) can be moved above the left handle rotation axis (the right handle rotation axis), and thus the center of gravity of the electrical device is sufficiently lowered when the user carries the electrical device. Thus, the user can stably carry the electrical device.

In one or more embodiments, the left handle rotation axis and the right handle rotation axis may be positioned above a horizontal plane that bisects the electrical device in an up-down direction.

If the left handle rotation axis (the right handle rotation axis) is positioned below the horizontal plane that bisects the electrical device in the up-down direction (which may be termed a horizontal bisection plane herein), the left handle (the right handle) is mounted on the case body at a relatively low position. Therefore, the center of gravity of the electrical device is not sufficiently lowered when the user carries it, and thus the user may not stably carry the electrical device. According to the configuration above, the left handle rotation axis (the right handle rotation axis) is positioned above the horizontal bisection plane, and thus the left handle (the right handle) is mounted on the case body at a relatively high position. Therefore, the center of gravity of the electrical device is sufficiently lowered when the user carries the electrical device, and thus the user can stably carry the electrical device.

In one or more embodiments, when the left handle is in the left upper position, a lower end of the left grip may be positioned above a horizontal plane that bisects the electrical device in an up-down direction. When the right handle is in the right upper position, a lower end of the right grip may be positioned above the horizontal plane that bisects the electrical device in the up-down direction.

If the lower end of the left grip (the right grip) cannot be moved above the horizontal bisection plane, the center of gravity of the electrical device may not be sufficiently lowered when the user carries it, which may hinder the user from stably carrying the electrical device. According to the configuration above, the lower end of the left grip (the right grip) can be moved above the horizontal bisection plane, and thus the center of gravity of the electrical device is sufficiently lowered when the user carries it. Thus, the user can stably carry the electrical device.

In one or more embodiments, the housing space of the case body may be open upwardly. The electrical device may further comprise a lid disposed at an upper portion of the case body and configured to open and close the housing space. When the left handle is in the left upper position, an upper end of the left grip may be positioned above an upper end of the case body. When the right handle is in the right upper position, an upper end of the right grip may be positioned above the upper end of the case body.

If the upper end of the left grip (the right grip) cannot be moved above the upper end of the case body, the center of gravity of the electrical device may not be sufficiently lowered when the user carries it, which may hinder the user from stably carrying the electrical device. According to the configuration above, the upper end of the left grip (the right grip) can be moved above the upper end of the case body, and thus the center of gravity of the electrical device is sufficiently lowered when the user carries it. Thus, the user can stably carry the electrical device.

In one or more embodiments, when the left handle is in the left upper position, a distance between an outer surface of the case body and an outer surface of the left grip may be 25 mm or more. When the right handle is in the right upper position, a distance between the outer surface of the case body and an outer surface of the right grip may be 25 mm or more.

If a user's hand grasping the left grip (the right grip) contacts the outer surface of the case body, the user may thereby feel uncomfortable. According to the configuration above, a clearance that is sufficiently larger than the thickness of the user's hand is secured between the outer surface of the case body and the outer surface of the left grip (the right grip). This clearance suppresses the user's hand grasping the left grip (the right grip) from contacting the outer surface of the case body and thus prevents the user from feeling uncomfortable.

In one or more embodiments, the electrical device may further comprise a lid configured to be movable relative to the case body between an open position where the lid opens the housing space and a closed position where the lid closes the housing space. When the lid is in the closed position and the left handle is in the left upper position, a distance between an outer surface of the lid and an outer surface of the left grip may be 25 mm or more. When the lid is in the closed position and the right handle is in the right upper position, a distance between the outer surface of the lid and an outer surface of the right grip may be 25 mm or more.

If a user's hand grasping the left grip (the right grip) contacts the outer surface of the lid, the user may thereby feel uncomfortable. According to the configuration above, a clearance that is sufficiently larger than the thickness of the user's hand is secured between the outer surface of the lid and the outer surface of the left grip (the right grip). This clearance suppresses the user's hand grasping the left grip (the right grip) from contacting the outer surface of the lid and thus prevents the user from feeling uncomfortable.

In one or more embodiments, when the left handle is in the left upper position and the right handle is in the right upper position, a lower end of the left grip and a lower end of the right grip may be positioned above a center of gravity of the electrical device with the battery pack attached to the battery receptacle.

If the lower end of the left grip (the right grip) cannot be moved above the center of gravity of the electrical device, the center of gravity of the electrical device may not be sufficiently lowered when the user carries it, which may hinder the user from stably carrying the electrical device. According to the configuration above, the lower end of the left grip (the right grip) can be moved above the center of gravity of the electrical device, and thus the center of gravity of the electrical device is sufficiently lowered when the user carries it. Thus, the user can stably carry the electrical device.

In one or more embodiments, the case body may have a substantially cuboid shape having a short direction along a front-rear direction and a longitudinal direction along a left-right direction.

For example, a user may carry the electrical device by himself/herself by grasping the left grip with one hand and grasping the right grip with the other hand, and in this case, the case body is positioned in front of the torso of the user. Thus, if the longitudinal direction of the case body is along the front-rear direction, the user may not carry the electrical device comfortably. By contrast, according to the configuration above, the case body has its short direction along the front-rear direction. This allows the user to carry the electrical device comfortably.

In one or more embodiments, the battery receptacle may be disposed in the housing space.

If the battery receptacle is disposed outside the housing space (e.g., on the outer surface of the case body), the battery pack attached in the battery receptacle is exposed to the outside of the housing space. In this case, the battery pack may bump an object (e.g., a tool, the ground, a wall, etc.) and thereby be damaged. According to the configuration above, the battery receptacle is disposed in the housing space, and this prevents the battery pack attached in the battery receptacle from being exposed to the outside of the housing space. Thus, the battery pack is prevented from bumping an object and being damaged.

In one or more embodiments, the housing space of the case body may be open upwardly. The electrical device may further comprise a lid disposed at an upper portion of the case body and configured to open and close the housing space. The battery pack may be attached to the battery receptacle by being slid along an up-down direction relative to the battery receptacle.

The configuration above facilitates attachment/detachment of the battery pack to/from the battery receptacle.

In one or more embodiments, the carrying case may further comprise a battery receptacle disposed on the case body. The battery pack may be attached to the battery receptacle.

The configuration above allows for positioning of the battery pack to the carrying case by attaching the battery pack to the battery receptacle.

In one or more embodiments, an electrical device may comprise: a case body defining a housing space; a battery receptacle disposed on the case body, wherein a battery pack used as a power supply for a power tool is attached to the battery receptacle; an external terminal disposed on the case body and configured to be electrically connected to the battery pack via the battery receptacle; a first surface which is a side surface of the case body; a first handle disposed on the first surface; and a first foot disposed on the first surface. The first handle may be movable relative to the case body between a retracted position where the first handle extends along the first surface and a deployed position where the first handle extends at an angle to the first surface. The electrical device may be configured to be placed on a placement surface such that the first surface is directed toward the placement surface, by bringing the first foot into contact with the placement surface. When the first handle is in the retracted position and the electrical device is on the placement surface with the first foot being in contact with the placement surface, a vertically lower end of the first handle may be positioned above a vertically lower end of the first foot.

In some cases, the electrical device may be placed on the placement surface with the first surface of the case body directed toward the placement surface. In this case, if the first handle disposed on the first surface contacts the placement surface, dirt (e.g., sand) on the placement surface may adhere to the first handle. According to the configuration above, when the electrical device is placed on the placement surface with the first surface of the case body directed toward the placement surface, the vertically lower end of the first handle is positioned above the vertically lower end of the first foot which is in contact with the placement surface. This prevents the first handle from contacting the placement surface, and thus prevents the dirt on the placement surface from adhering to the first handle.

In one or more embodiments, the first handle may be configured to be rotatable about a first handle rotation axis relative to the case body between the retracted position and the deployed position.

The configuration above allows the first handle to move between the retracted position and the deployed position in a simple manner.

In one or more embodiments, the first foot may comprise a contact portion configured to contact the placement surface. A rubber material is used for the contact portion.

In the configuration above, when the electrical device is placed on the placement surface with the first foot (the contact portion) contacting the placement surface, the friction resistance between the first foot (the contact portion) and the placement surface is relatively large. This suppresses changes in the position of the electrical device on the placement surface even when an impact and/or vibration is applied to the electrical device.

In one or more embodiments, the electrical device may further comprise a second surface which is a side surface of the case body and faces in an opposite direction to a direction in which the first surface faces; and a second handle disposed on the second surface.

The configuration above allows the user to carry the electrical device by grasping the first handle with one hand and grasping the second handle with the other hand. Thus, the user can carry the electrical device easily.

In one or more embodiments, the electrical device may further comprise a third surface which is a side surface of the case body and different from the first surface and the second surface; and a second foot disposed on the third surface. The electrical device may be configured to be placed on the placement surface such that the third surface is directed toward the placement surface, by bringing the second foot into contact with the placement surface.

The configuration above allows the electrical device to be placed on the placement surface with the surface on which neither of the first handle nor the second handle is disposed (i.e., the third surface) directed toward the placement surface.

In one or more embodiments, a carrying case may be configured to allow the user to carry at least one of a manual tool, a power tool, and a battery pack used as a power supply for a power tool. The carrying case may comprise a case body defining a housing space; a first surface which is a side surface of the case body; a first handle disposed on the first surface; and a first foot disposed on the first surface. The first handle may be movable relative to the case body between a retracted position where the first handle extends along the first surface and a deployed position where the first handle extends at an angle to the first surface. The carrying case may be configured to be placed on a placement surface such that the first surface is directed toward the placement surface, by bringing the first foot into contact with the placement surface. When the first handle is in the retracted position and the carrying case is on the placement surface with the first foot being in contact with the placement surface, the vertically lower end of the first handle may be positioned above the vertically lower end of the first foot.

In some cases, the carrying case may be placed on the placement surface with the first surface of the case body directed toward the placement surface. In this case, if the first handle disposed on the first surface contacts the placement surface, dirt (e.g., sand) on the placement surface may adhere to the first handle. According to the configuration above, when the carrying case is placed on the placement surface with the first surface of the case body directed toward the placement surface, the vertical lower end of the first handle is positioned above the vertical lower end of the first foot which is in contact with the placement surface. This prevents the first handle from contacting the placement surface, and thus prevents the dirt on the placement surface from adhering to the first handle.

### First Embodiment: Charger 2

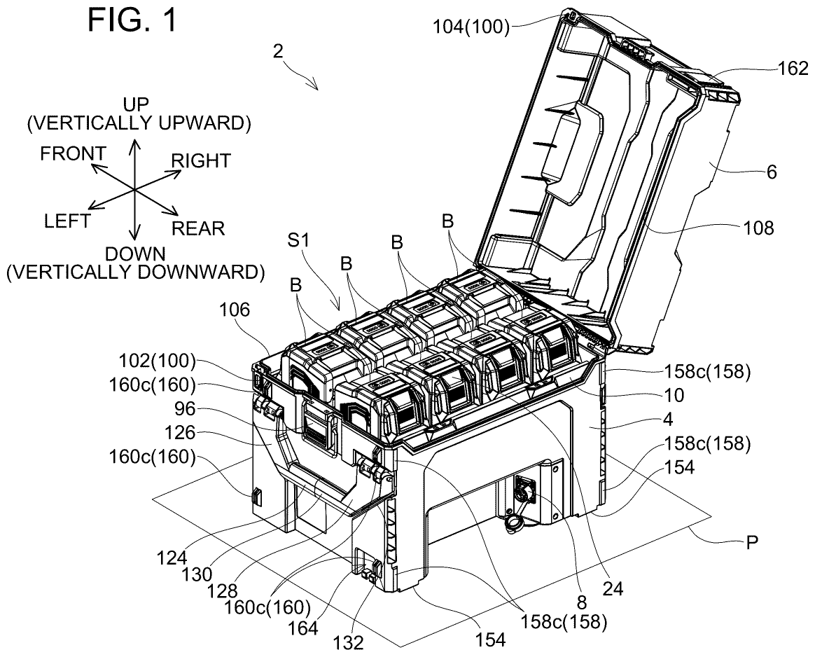

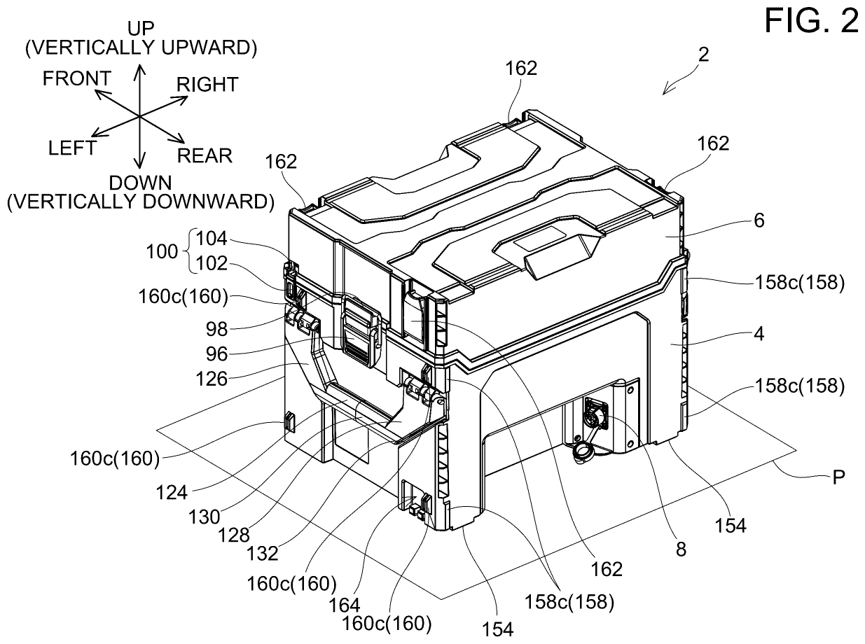

A charger 2 shown in FIG. 1 is an electrical device configured to charge a plurality of battery packs B. The charger 2 has a substantially cuboid shape. The charger 2 comprises a case body 4 defining a housing space S1 for housing one or more objects (e.g., the battery packs B) and a lid 6 configured to open and close the housing space S1. In this embodiment, for example, a PC+ABS resin (polycarbonate polymer alloy) is used for the case body 4. For example, PC (polycarbonate) is used for the lid 6. The lid 6 is movable relative to the case body 4 between an open position where the lid 6 opens the housing space S1 (see FIG. 1) and a closed position where the lid 6 closes the housing space S1 (see FIG. 2). A user can remove/put an object from/into the housing space S1 when the lid 6 is in the open position. An external terminal 8 is disposed on the case body 4 to connect a dedicated AC adaptor (not shown). The AC adaptor converts AC power supplied from an external power supply, such as a commercial power supply to DC power and supplies it to the charger 2.

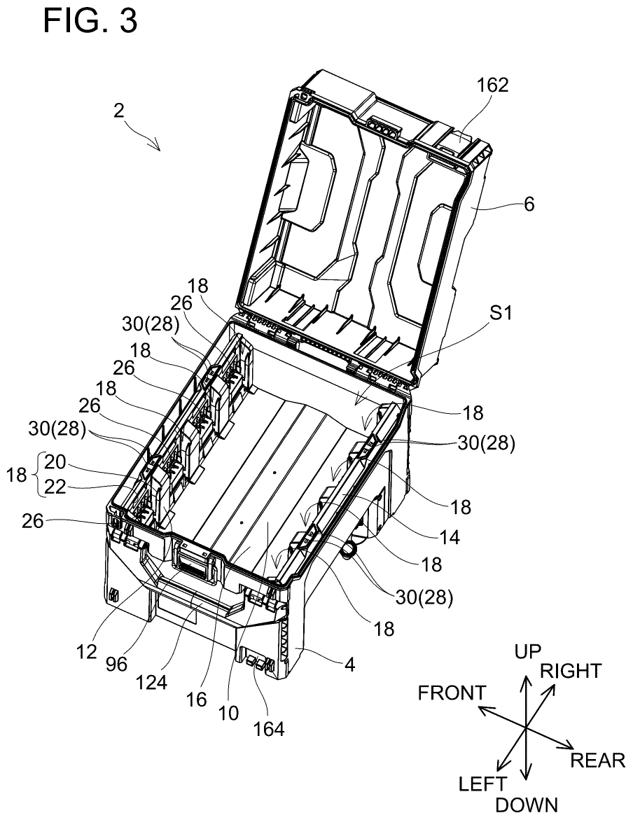

As shown in FIGS. 1 and 2, the charger 2 can be placed on a placement surface P such as the ground such that the housing space S1 is open vertically upward and the top surface of the lid 6 is directed vertically upward when the lid 6 is in the closed position. Here, “vertically upward” can be rephrased as a direction perpendicular to the placement surface P. In the disclosure herein, a front-rear direction, a left-right direction, and an up-down direction of the charger 2 are defined based on the orientation of the charger 2 shown in FIGS. 1 and 2. Specifically, the up-down direction of the charger 2 is defined as a vertically up-down direction when the charger 2 is in the orientation shown in FIGS. 1 and 2; the left-right direction of the charger 2 is defined as a direction that is perpendicular to the up-down direction and along the longitudinal direction of the charger 2; and the front-rear direction of the charger 2 is defined as the direction perpendicular to the up-down direction and the left-right direction. Regarding the front-rear direction, the rear direction is toward the external terminal 8 and the front direction is the opposite direction. In some of FIGS. 3 to 21 (specifically, in FIGS. 3 to 9 and 12 to 20), the depiction of the placement surface P is omitted.

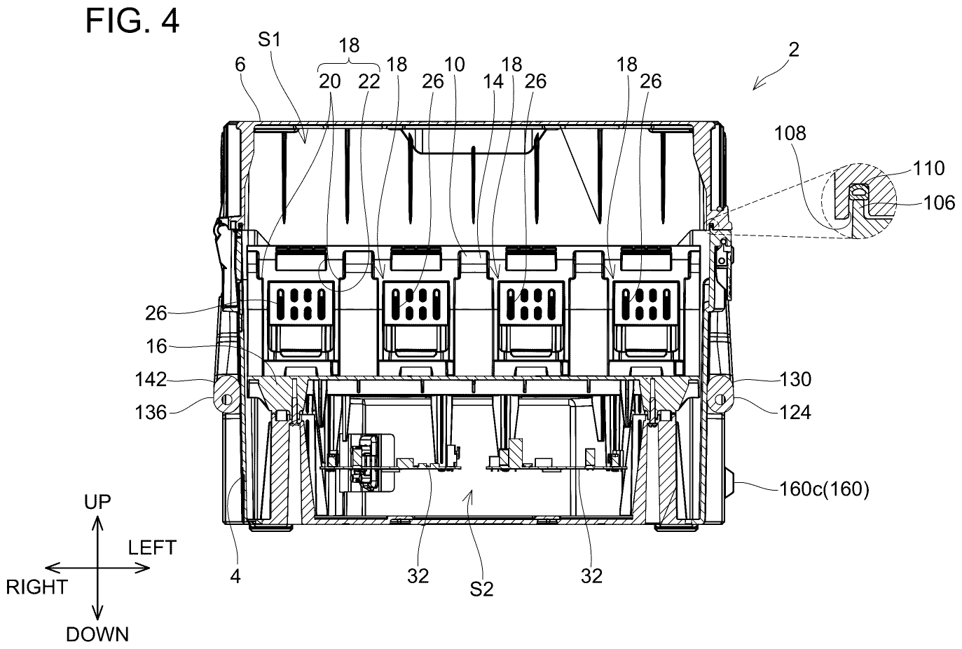

As shown in FIG. 3, a tray member 10 is fixed to the case body 4. The tray member 10 comprises a front wall 12, a rear wall 14, and a bottom wall 16. The front wall 12 extends in the up-down direction and the left-right direction along the front wall of the case body 4. The rear wall 14 extends in the up-down direction and the left-right direction along the rear wall of the case body 4. As shown in FIG. 4, the bottom wall 16 is separated from the bottom wall of the case body 4 and extends in the front-rear direction and the left-right direction. As shown in FIG. 3, eight battery receptacles 18 are located on the tray member 10. Four of the battery receptacles 18 are located on the rear surface of the front wall 12 and the other four battery receptacles 18 are located on the front surface of the rear wall 14. Each battery receptacle 18 comprises a guide rail 20 and a latch receiver 22. To attach a battery pack B (see FIG. 1) to a battery receptacle 18, the battery pack B is slid downward relative to the battery receptacle 18. In the course of attachment, the guide rail 20 is inserted into a guide groove (not shown) defined in the battery pack B and a latch 24 (see FIG. 1) located on the battery pack B engages with the latch receiver 22. Once the insertion and engagement have been completed, the attachment of the battery pack B is completed. To detach the battery pack B from the battery receptacle 18, the latch 24 is disengaged from the latch receiver 22 by a manipulation onto the latch 24 and then the battery pack B is slid upward relative to the battery receptacle 18. Once the guide rail 20 has been pulled out from the guide groove of the battery pack B, the detachment of the battery pack B is completed. Further, eight connection terminals 26 (some of these are not shown) are located on the rear surface of the front wall 12 and the front surface of the rear wall 14. Each of the connection terminals 26 is assigned to corresponding one of the battery receptacles 18. The connection terminals 26 are electrically connected to the battery packs B attached in the battery receptacles 18. When the charger 2 charges the battery packs B, electric power is supplied from the charger 2 to the battery packs B via the connection terminals 26. Further, eight charging state displays 28 are located on upper surfaces of the front wall 12 and the rear wall 14. Each of the charging state displays 28 is assigned to corresponding one of the battery receptacles 18. Each charging state display 28 comprises a light-emitting element (e.g., an LED), which is not shown, and a display window 30 configured to allow the light from the light-emitting element to pass therethrough. Each charging state display 28 displays a charging state of the battery pack B attached in the corresponding battery receptacle 18 by using the light emitted by the light-emitting element. For example, each charging state display 28 selectively displays that the battery pack B is being charged, that the charging of the battery pack B has been completed, or that an abnormality (e.g., overcurrent) has occurred during the charging of the battery pack B.

The battery packs B shown in FIG. 1 are each used as a power supply for a power tool (e.g., a driver, a chainsaw, etc.), which is not shown, and configured to be detachably attached to the power tool. The weight of a single battery pack B is for example two kilograms. The weight of the charger 2 with none of the battery packs B attached in any of the eight battery receptacles 18 is for example six kilograms. Thus, the weight of the charger 2 with the battery packs B attached in all of the eight battery receptacles 18 is for example 22 kilograms.

As shown in FIG. 4, the charger 2 further comprises a control board 32 configured to control the charger 2. The control board 32 is located in a board space S2 which is defined by the case body 4 and located below the tray member 10. The housing space S1 and the board space S2 are separated from each other by the tray member 10. The control board 32 is electrically connected to the external terminal 8, the connection terminals 26, and the charging state displays 28 via wires (not shown) located in the board space S2. The control board 32 can charge the battery packs B for example by supplying electric power supplied to the charger 2 via the external terminal 8 to the battery packs B via the connection terminals 26.

### Coupling Mechanism 34

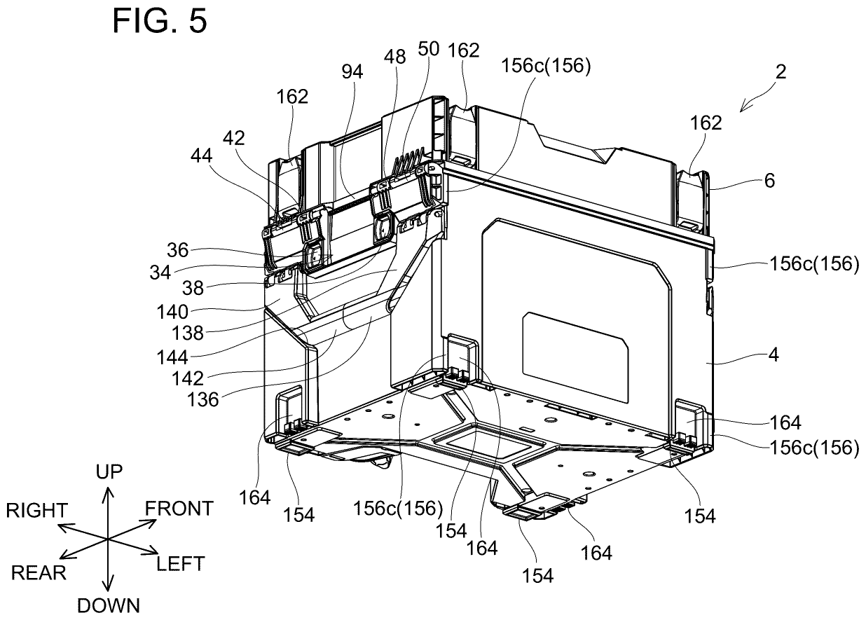

As shown in FIG. 5, the charger 2 further comprises a coupling mechanism 34 that couples the case body 4 and the lid 6 to each other. The coupling mechanism 34 is located on the right surface of the charger 2. The coupling mechanism 34 comprises a first coupling member 36 and a second coupling member 38 located forward of the first coupling member 36. The first coupling member 36 and the second coupling member 38 are detachably attached to the case body 4.

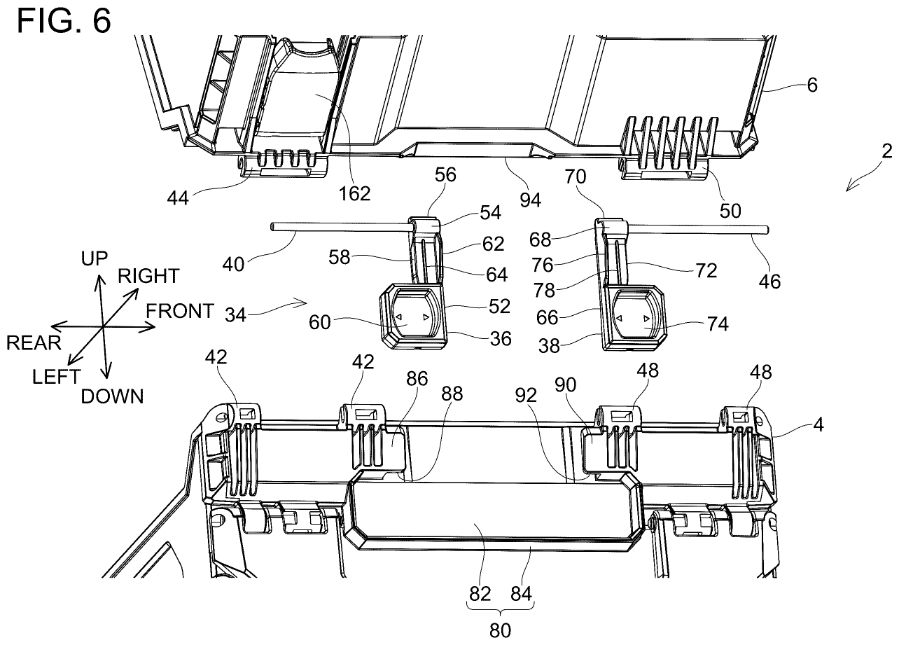

As shown in FIG. 6, the first coupling member 36 comprises a first coupling pin 40. The first coupling pin 40 extends in the front-rear direction. A first case-side tube 42 is located on the case body 4, and the first case-side tube 42 is configured to allow the first coupling pin 40 to be inserted therein. A first lid-side tube 44 is located on the lid 6, and the first lid-side tube 44 is configured to allow the first coupling pin 40 to be inserted therein. The first coupling pin 40 is inserted in both the first case-side tube 42 and the first lid-side tube 44 to couple the case body 4 and the lid 6 such that they are rotatable to each other. The second coupling member 38 comprises a second coupling pin 46. The second coupling pin 46 extends in the front-rear direction. A second case-side tube 48 is located on the case body 4, and the second-case-side tube 48 is configured to allow the second coupling pin 46 to be inserted therein. A second lid-side tube 50 is located on the lid 6, and the second lid-side tube 50 is configured to allow the second coupling pin 46 to be inserted therein. The second coupling pin 46 is inserted in both the second case-side tube 48 and the second lid-side tube 50 to couple the case body 4 and the lid 6 such that they are rotatable to each other. Thus, the lid 6 is movable between the open position shown in FIG. 1 and the closed position shown in FIG. 2 by rotating about the first coupling pin 40 and the second coupling pin 46. In the disclosure herein, an opening degree of the lid 6 (i.e., how much the lid 6 is opened) is expressed in a rotation angle of the lid 6 relative to the closed position. The opening degree of the lid 6 in the open position shown in FIG. 1 is for example in a range from 45 degrees to 180 degrees, and in this embodiment, it is 115 degrees.

As shown in FIG. 6, the first coupling member 36 further comprises a first manipulatable portion 52. The first manipulatable portion 52 comprises a holding portion 54 holding the front end of the first coupling pin 40, a projection 56 projecting upward from the holding portion 54, an extension 58 extending downward from the holding portion 54, a finger pad 60 connected to the lower end of the extension 58, a wall 62 connected to the front end of the extension 58, and an engagement rib 64 located on the right surface of the extension 58. The wall 62 extends in the up-down direction and the left-right direction (directions perpendicular to the axial direction of the first coupling pin 40). The finger pad 60, the wall 62, and the engagement rib 64 are offset downward (in the radial direction of the first coupling pin 40) from the first coupling pin 40. The second coupling member 38 further comprises a second manipulatable portion 66. The second manipulatable portion 66 comprises a holding portion 68, a projection 70, an extension 72, a finger pad 74, a wall 76, and an engagement rib 78. Descriptions for these elements of the second manipulatable portion 66 are omitted since the configuration of the second manipulatable portion 66 is in mirror symmetry to the configuration of the first manipulatable portion 52 of the first coupling member 36.

A guide 80 is located on the case body 4, and the guide 80 is configured to receive the first manipulatable portion 52 and the second manipulatable portion 66 such that they are slidable in the front-rear direction (in the axial direction of the coupling pins 40, 46). The guide 80 comprises a guide surface 82 that contacts the left surfaces of the first manipulatable portion 52 and the second manipulatable portion 66 such that they are slidable in the front-rear direction; and a guide wall 84 that supports the lower ends of the first manipulatable portion 52 and the second manipulatable portion 66 such that they are slidable in the front-rear direction. An engagement piece 86 is located on a portion of the case body 4 that faces the right surface of the extension 58. An engagement groove 88 configured to engage with the engagement rib 64 is defined in the left surface of the engagement piece 86. Similarly, an engagement piece 90 is located on a portion of the case body 4 that faces the right surface of the extension 72. An engagement groove 92 configured to engage with the engagement rib 78 is defined in the left surface of the engagement piece 90.

As shown in FIG. 5, the first coupling member 36 and the second coupling member 38 are typically attached on the outer surface of the case body 4. That is, the first coupling member 36 is attached on the case body 4 such that the first coupling pin 40 (see FIG. 6) is inserted in both the first case-side tube 42 and the first lid-side tube 44 and the engagement rib 64 (see FIG. 6) is engaged with the engagement groove 88 (see FIG. 6). The position of the first coupling member 36 in this state is herein termed “first coupling position”. Further, the second coupling member 38 is attached on the case body 4 such that the second coupling pin 46 (see FIG. 6) is inserted in both the second case-side tube 48 and the second lid-side tube 50 and the engagement rib 78 (see FIG. 6) is engaged with the engagement groove 92 (see FIG. 6). The position of the second coupling member 38 in this state is herein termed “second coupling position”.

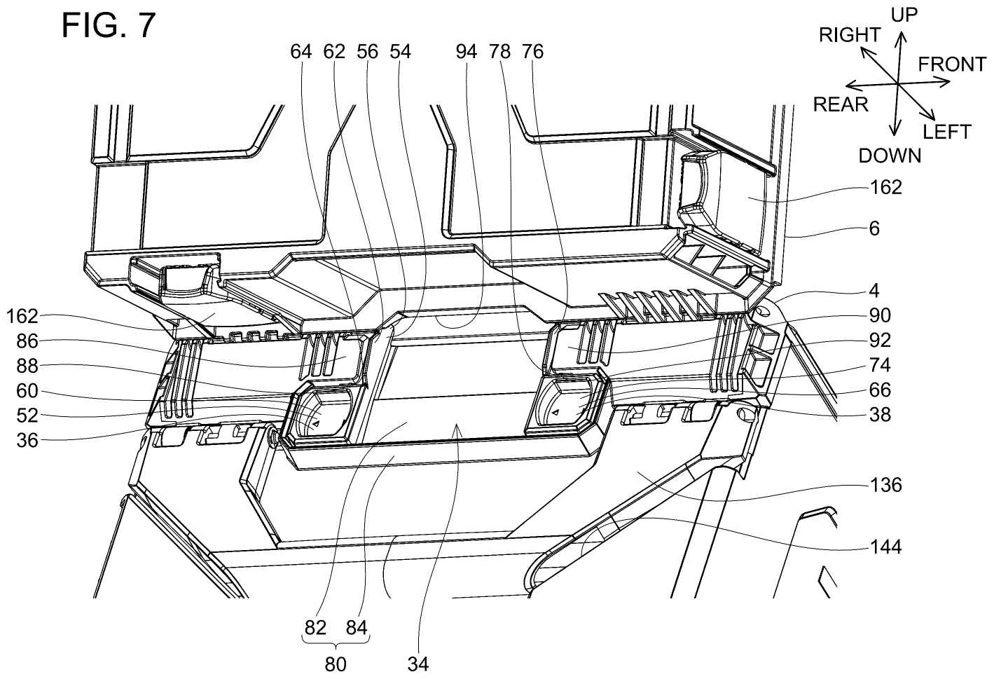

A blocking projection 94 is located on the lid 6. The blocking projection 94 projects downward from the lower end of the right wall of the lid 6. As the lid 6 in the closed position is viewed in the front-rear direction (in the axial direction of the coupling pins 40, 46), the blocking projection 94 overlaps the projection 56 of the first coupling member 36 (the projection 70 of the second coupling member 38) (see FIG. 6). In this state, the projection 56 (the projection 70) is blocked by the blocking projection 94 when the user attempts to move the first coupling member 36 (the second coupling member 38) forward (rearward) from the first coupling position (the second coupling position). Thus, the first coupling member 36 (the second coupling member 38) is prevented from further moving forward (rearward). However, as shown in FIG. 7, once the opening degree of the lid 6 exceeds a predetermined blocking avoidance degree, the blocking projection 94 no longer overlaps the projection 56 (the projection 70) (see FIG. 6) as the lid 6 is viewed in the front-rear direction (in the axial direction of the coupling pins 40, 46). Thus, the projection 56 (the projection 70) is no longer blocked by the blocking projection 94 when the first coupling member 36 (the second coupling member 38) is moved forward (rearward) from the first coupling position (the second coupling position). Thus, the first coupling member 36 (the second coupling member 38) is permitted to be moved in the front-rear direction (in the axial direction of the coupling pins 40, 46). The blocking avoidance degree here is for example in a range from 45 degrees to 180 degrees, and in this embodiment, it is 90 degrees.

Once the opening degree of the lid 6 exceeds the blocking avoidance degree, the user can disengage the engagement rib 64 from the engagement groove 88 by applying a forward force on the first coupling member 36 and then move the first coupling member 36 forward from the first coupling position. When applying the forward force, the user may put a finger on the finger pad 60 and apply the forward force on the finger pad 60 (the first coupling member 36). Alternatively, the user may insert a plate-shaped object (not shown), such as a coin, into a clearance between the rear surface of the wall 62 and the front surface of the engagement piece 86 and use the plate-shaped object according to the principle of leverage to apply the forward force on the wall 62 (the first coupling member 36). In this case, a portion of the plate-shaped object that contacts the engagement piece 86 is the fulcrum, a portion of the plate-shaped object that contacts the user is the effort, and a portion of the plate-shaped object that contacts the wall 62 is the load.

Further, once the opening degree of the lid 6 exceeds the blocking avoidance degree, the user can disengage the engagement rib 78 from the engagement groove 92 by applying a rearward force on the second coupling member 38 and then move the second coupling member 38 rearward from the second coupling position. When applying the rearward force, the user may put a finger on the finger pad 74 and apply the rearward force on the finger pad 74 (the second coupling member 38). Alternatively, the user may insert a plate-shaped object (not shown), such as a coin, into a clearance between the front surface of the wall 76 and the rear surface of the engagement piece 90 and use the plate-shaped object according to the principle of leverage to apply the rearward force on the wall 76 (the second coupling member 38). In this case, a portion of the plate-shaped object that contacts the engagement piece 90 is the fulcrum, a portion of the plate-shaped object that contacts the user is the effort, and a portion of the plate-shaped object that contacts the wall 76 is the load.

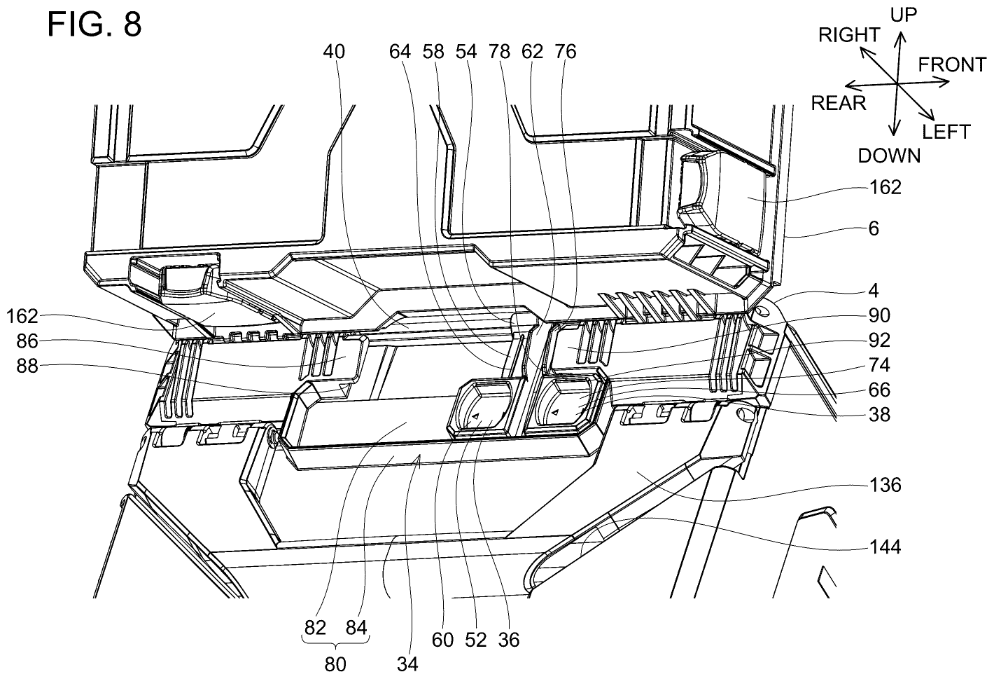

As shown in FIG. 8, as the first coupling member 36 is moved forward from the first coupling position (the position shown in FIG. 7), the first coupling pin 40 is pulled out from the first lid-side tube 44 (see FIG. 6), thereby the coupling of the case body 4 with the lid 6 formed by the first coupling pin 40 is released. In the disclosure herein, the position of the first coupling member 36 upon when the first coupling pin 40 has just been pulled out from the first lid-side tube 44 is termed “first decoupled position”. As the first coupling member 36 is further moved forward, the first coupling pin 40 is also pulled out from the first case-side tube 42 (see FIG. 6). In this state, the first coupling member 36 can be detached from the case body 4. The second coupling member 38 in the second coupling position does not interrupt the first coupling member 36 while the first coupling pin 40 is being pulled out from the first case-side tube 42 and the first lid-side tube 44.

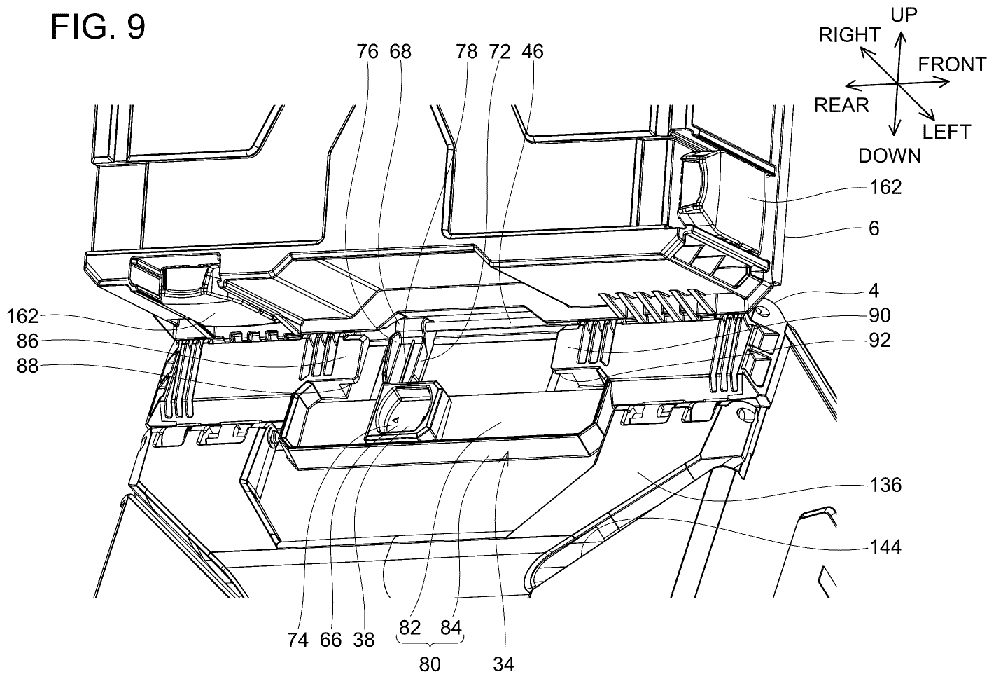

As shown in FIG. 9, as the second coupling member 38 is moved rearward from the second coupling position (the position shown in FIGS. 7 and 8), the second coupling pin 46 is pulled out from the second lid-side tube 50 (see FIG. 6), thereby the coupling of the case body 4 with the lid 6 formed by the second coupling pin 46 is released. In the disclosure herein, the position of the second coupling member 38 upon when the second coupling pin 46 has just been pulled out from the second lid-side tube 50 is termed “second decoupled position”. As the second coupling member 38 is further moved rearward, the second coupling pin 46 is also pulled out from the second case-side tube 48 (see FIG. 6). In this state, the second coupling member 38 can be detached from the case body 4.

In the example shown in FIGS. 7-9, the second coupling member 38 is detached after the first coupling member 36 has been detached first. However, the first coupling member 36 may be detached after the second coupling member 38 has been detached first.

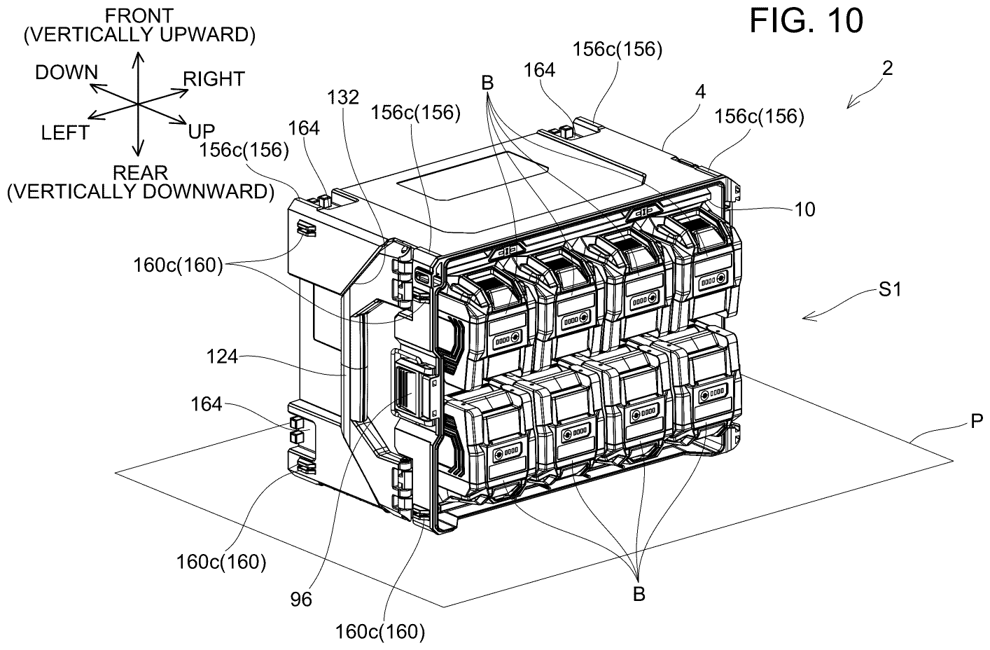

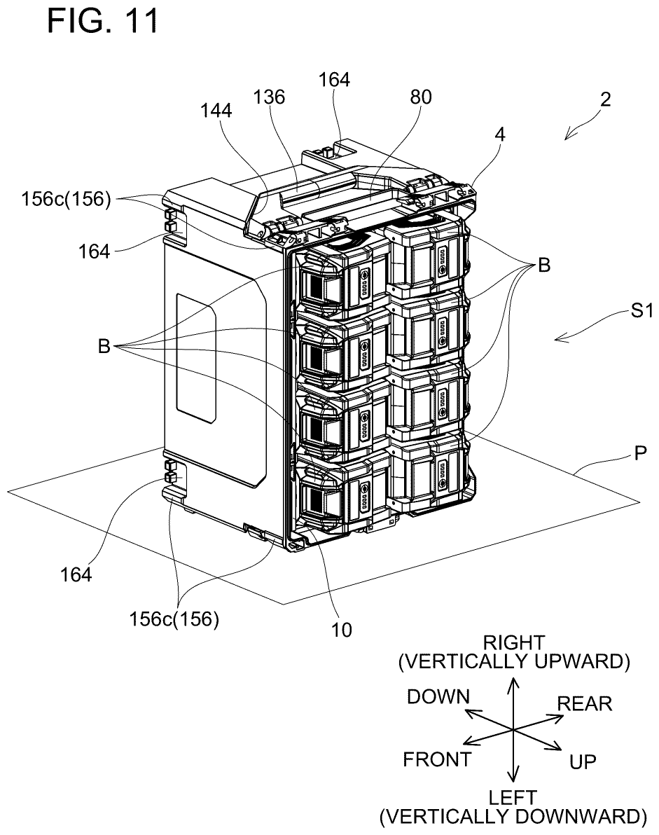

In this embodiment, one of the first coupling member 36 and the second coupling member 38 is first detached from the case body 4 and then the other of the first coupling member 36 and the second coupling member 38 is moved to the decoupled position, so that the case body 4 and the lid 6 are decoupled from each other and the lid 6 can thus be detached from the case body 4. Leaving the charger 2 without the lid 6 attached in the case body 4, as shown in FIGS. 10 and 11, allows the user to access the housing space S1 without an effort to open the lid 6. Thus, the user can access the housing space S1 easily. Further, the charger 2 without the lid 6 is smaller in size, and thus a space required to install the charger 2 is reduced.

To attach the lid 6 again to the case body 4 after it has been detached from the case body 4, as shown in FIG. 6, the lid 6 is first positioned relative to the case body 4 such that the first lid-side tube 44, the first case-side tube 42, the second case-side tube 48, and the second lid-side tube 50 are aligned in their axial direction. Then, the orientation of the lid 6 is adjusted relative to the case body 4 such that the opening degree of the lid 6 exceeds the blocking avoidance degree, and after that, the first coupling member 36 and the second coupling member 38 are attached. The first coupling member 36 and the second coupling member 38 are attached by performing the steps for detaching the first coupling member 36 and the second coupling member 38, which were described referring to FIGS. 7 to 9, in the reverse order, and thus how the first coupling member 36 and the second coupling member 38 are attached is not described in detail here.

### Retainer 96 and Locking Section 100

As shown in FIG. 2, a retainer 96 (e.g., a draw latch) for retaining the lid 6 in the closed position is located on the left surface of the case body 4. A groove 98 for the retainer 96 is defined in the lid 6. Further, a locking section 100 is located on the left surface of the charger 2 and forward of the retainer 96 and the groove 98, and the locking section 100 is configured to be locked with a padlock (not shown). The locking section 100 comprises a case-side lock hole 102 defined in the case body 4 and a lid-side lock hole 104 defined in the lid 6. The user can lock the locking section 100 by inserting the shackle of a padlock into the case-side lock hole 102 and the lid-side lock hole 104. While the locking section 100 is locked, the lid 6 is prohibited from moving from the closed position to the open position. Specifically, while the locking section 100 is locked, the lid 6 cannot be opened enough for an object (e.g., a battery pack B) to be removed from or put into the housing space S1.

### Sealing Member 110

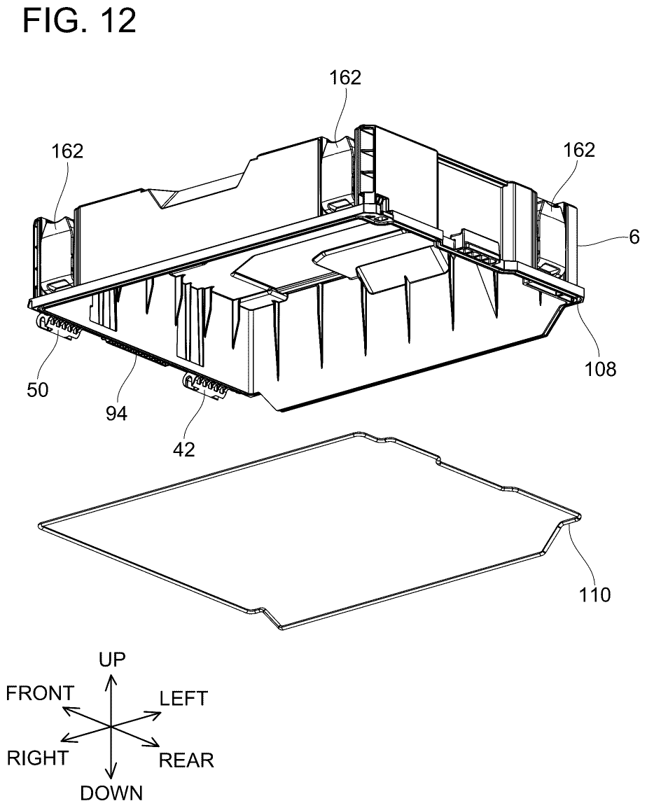

As shown in FIG. 1, an engagement groove 108 configured to receive an opening edge 106 of the case body 4 is defined in the lid 6. The engagement groove 108 is defined along ends of side walls of the lid 6. As shown in FIG. 12, a sealing member 110 is housed in the engagement groove 108. When the lid 6 is in the closed position as shown in FIG. 4, the opening edge 106 of the case body 4 is received in the engagement groove 108, and the sealing member 110 housed in the engagement groove 108 is compressed between the opening edge 106 of the case body 4 and the bottom surface of the engagement groove 108. Thus, when the lid 6 is in the closed position, the sealing member 110 provides sealing between the case body 4 and the lid 6. This prevents a liquid such as water from entering the case body 4 (i.e., the housing space S1) from the outside.

### Surface Treatment on Lid 6

In this embodiment, the lid 6 has visible light permeability. Thus, the user can see the inside (i.e., the housing space S1) of the case body 4 through the lid 6.

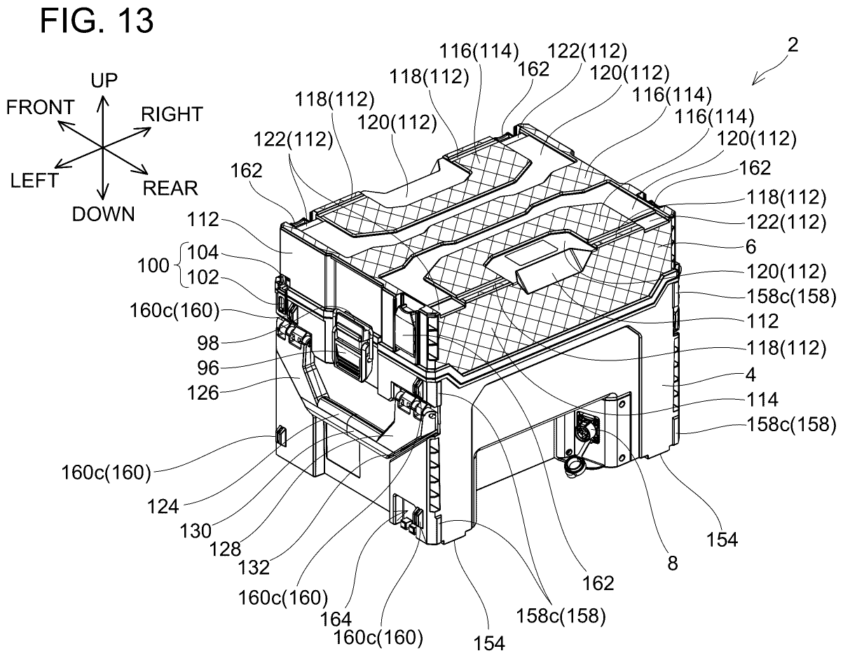

As shown in FIGS. 13 to 15, the outer surface of the lid 6 comprises a clear surface 112 and a textured surface 114. Scratches, if any, on the clear surface 112 are noticeable, but the clear surface 112 has an advantage that it is excellent in visible light permeability. By contrast, the textured surface 114 is inferior in visible light permeability to the clear surface 112 but has an advantage that scratches on the textured surface 114 are less noticeable. In FIGS. 13 to 15, the textured surface 114 is patterned with mesh to aid understanding of the drawings. However, the pattern on the textured surface 114 is not limited to mesh. The pattern on the textured surface 114 may be similar to, for example, a grain texture (creases) of leather products.

As shown in FIG. 13, the left surface of the lid 6 is almost entirely formed by the clear surface 112. The rear surface of the lid 6 is almost entirely formed by the textured surface 114. The upper surface of the lid 6 comprises a top surface 116, a first recessed surface 118 which is recessed by a first depth (e.g., 2 mm) downward from the top surface 116, a second recessed surface 120 which is recessed by a second depth (e.g., 3 mm) downward from the top surface 116, and a third recessed surface 122 which is recessed by a third depth (e.g., 4 mm) downward from the top surface 116. Within the upper surface of the lid 6, the top surface 116 is formed by the textured surface 114, whereas the first recessed surface 118, the second recessed surface 120, and the third recessed surface 122 are formed by the clear surface 112.

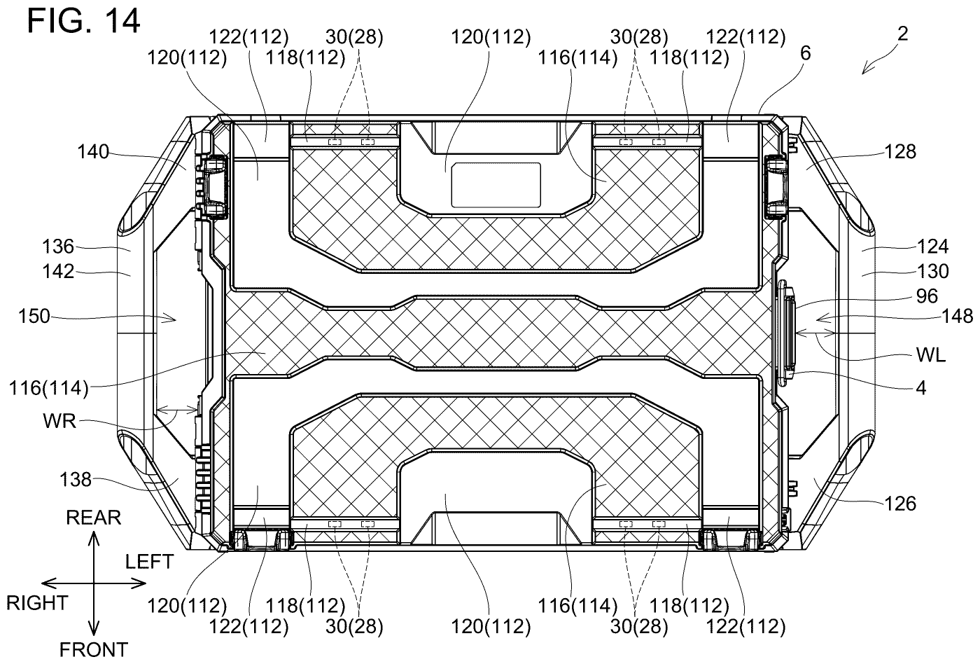

As shown in FIG. 14, in the top view of the charger 2 with the lid 6 being in the closed position, the display windows 30 of the charging state displays 28 entirely overlap the first recessed surface 118 (clear surface 112). Thus, when seeing the housing space S1 from above through the lid 6, the user can see the charging state displays 28 relatively clearly.

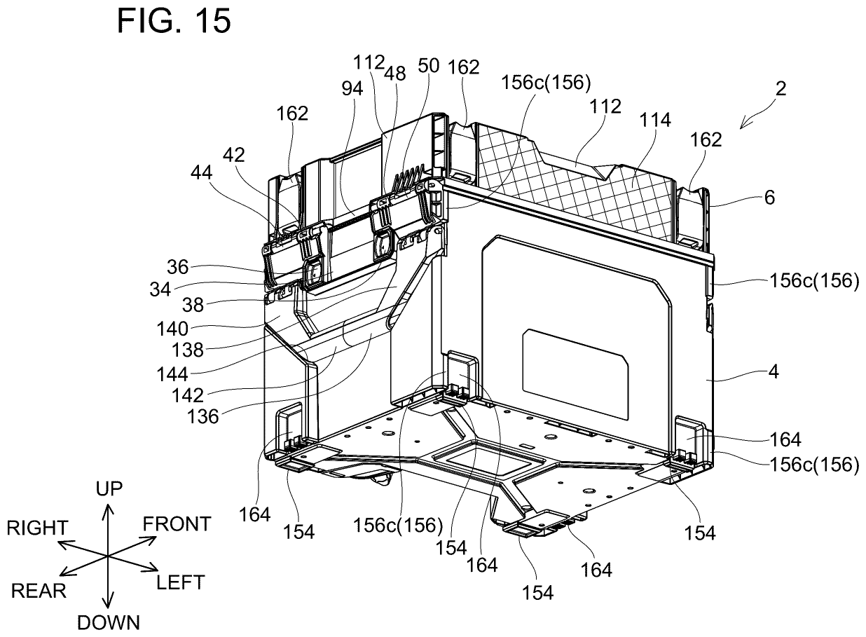

As shown in FIG. 15, the front surface of the lid 6 is almost entirely formed by the textured surface 114. The right surface of the lid 6 is almost entirely formed by the clear surface 112.

### Left Handle 124 and Right Handle 136

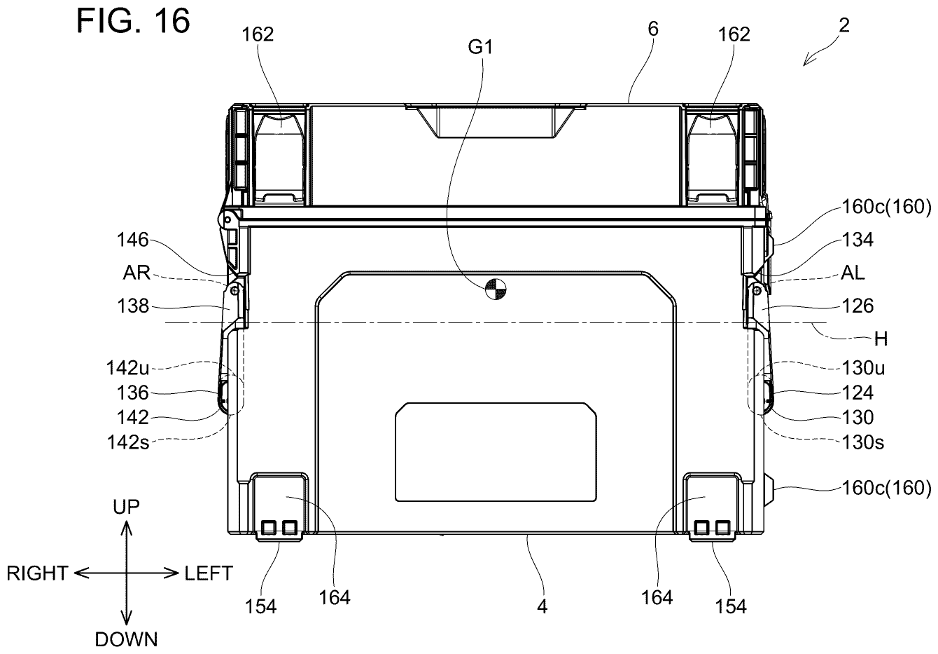

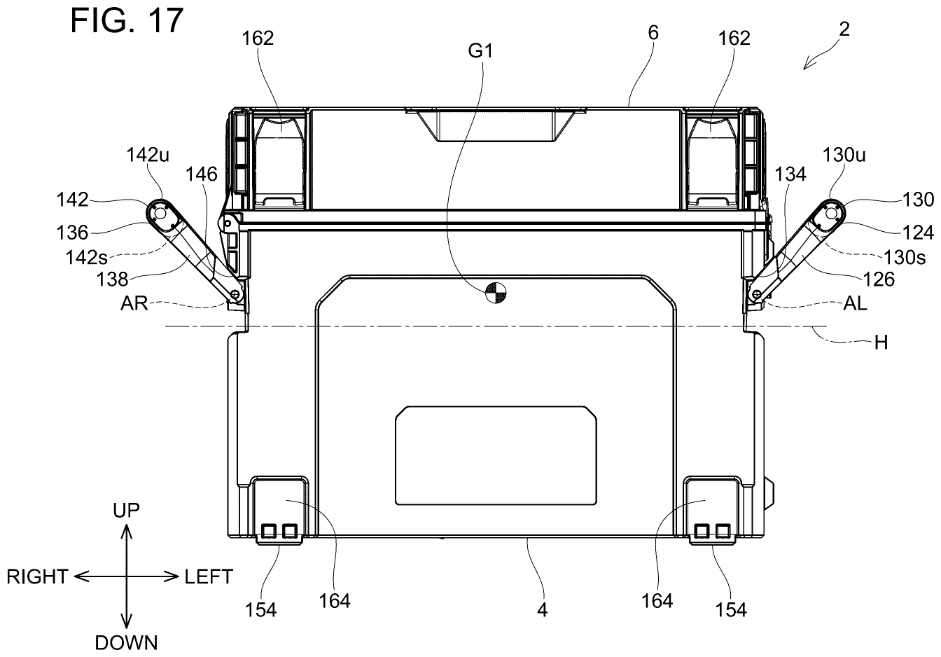

As shown in FIG. 2, a left handle 124 is disposed on the left surface of the case body 4. The weight of the left handle 124 is for example 100 grams. The left handle 124 comprises a front arm 126, a rear arm 128, and a grip 130. The grip 130 extends in the front-rear direction and connecting one end of the front arm 126 to one end of the rear arm 128. The other ends of the front arm 126 and the rear arm 128 are mounted on the case body 4 such that they are rotatable about a handle rotation axis AL (see FIGS. 16, 17) extending in the front-rear direction. Further, a handle receiving recess 132 is defined in the case body 4, and the handle receiving recess 132 is recessed rightward from the left surface of the case body 4. The handle receiving recess 132 has a shape corresponding to the shape of the left handle 124. In the state shown in FIG. 2, the left handle 124 is partially received in the handle receiving recess 132 and the right surface of the left handle 124 is in contact with the bottom surface of the handle receiving recess 132. As viewed from the front, the left handle 124 in this state cannot be further rotated clockwise. FIG. 16 shows the front view of the charger 2 in this state. In the front view, as the left handle 124 is rotated counterclockwise from the position shown in FIG. 16, the upper surface of the left handle 124 comes to contact a stopper surface 134 of the case body 4 (see FIG. 17). In the state where the upper surface of the left handle 124 is in contact with the stopper surface 134, as shown in FIG. 17, the left handle 124 cannot be further rotated counterclockwise as viewed from the front. Thus, the left handle 124 is rotatable between the position shown in FIG. 16 and the position shown in FIG. 17. During the rotation of the left handle 124, the grip 130 assumes the lowest position when the left handle 124 is in the position shown in FIG. 16 and assumes the highest position when the left handle 124 is in the position shown in FIG. 17. In the disclosure herein, the position of the left handle 124 shown in FIG. 16 is termed “left lower position” and the position of the left handle 124 shown in FIG. 17 is termed “left upper position”.

As shown in FIG. 5, a right handle 136 is disposed on the right surface of the case body 4. The weight of the right handle 136 is for example 100 grams. The right handle 136 comprises a front arm 138, a rear arm 140, and a grip 142. The grip 142 extends in the front-rear direction and connecting one end of the front arm 138 to one end of the rear arm 140. The other ends of the front arm 138 and the rear arm 140 are mounted on the case body 4 such that they are rotatable about a handle rotation axis AR (see FIGS. 16, 17) extending in the front-rear direction. Further, a handle receiving recess 144 is defined in the case body 4, and the handle receiving recess 144 is recessed leftward from the right surface of the case body 4. The handle receiving recess 144 has a shape corresponding to the shape of the right handle 136. In the state shown in FIG. 5, the right handle 136 is partially received in the handle receiving recess 144 and the left surface of the right handle 136 is in contact with the bottom surface of the handle receiving recess 144. As viewed from the front, the right handle 136 in this state cannot be further rotated counterclockwise. FIG. 16 shows the front view of the charger 2 in this state. In the front view, as the right handle 136 is rotated clockwise from the position shown in FIG. 16, the upper surface of the right handle 136 comes to contact a stopper surface 146 of the case body 4 (see FIG. 17). In the state where the upper surface of the right handle 136 is in contact with the stopper surface 146, as shown in FIG. 17, the right handle 136 cannot be further rotated clockwise as viewed from the front. Thus, the right handle 136 is rotatable between the position shown in FIG. 16 and the position shown in FIG. 17. During the rotation of the right handle 136, the grip 142 assumes the lowest position when the right handle 136 is in the position shown in FIG. 16 and assumes the highest position when the right handle 136 is in the position shown in FIG. 17. In the disclosure herein, the position of the right handle 136 shown in FIG. 16 is termed “right lower position” and the position of the right handle 136 shown in FIG. 17 is termed “right upper position”.

For example, the user can move the left handle 124 to the left upper position and the right handle 136 to the right upper position to grab the grip 130 with one hand and the grip 142 with the other hand to carry the charger 2. Further, the user can move the left handle 124 to the left lower position and the right handle 136 to the right lower position so that the left handle 124 and the right handle 136 are positioned not to interrupt the opening and closing of the lid 6 and an object to be removed from and put into the housing space S1.

As shown in FIG. 16, the handle rotation axis AL of the left handle 124 is positioned above a horizontal bisection plane H that bisects the charger 2 in the up-down direction and above a center of gravity G1 of the charger 2. When the left handle 124 is in the left lower position, an upper end 130u of the grip 130 is positioned below the handle rotation axis AL, below the horizontal bisection plane H, and below the opening edge 106 of the case body 4 (i.e., the upper end of the case body 4) (see FIG. 1). Similarly, the handle rotation axis AR of the right handle 136 is positioned above the horizontal bisection plane H and above a center of gravity G1 of the charger 2. When the right handle 136 is in the right lower position, an upper end 142u of the grip 142 is positioned below the handle rotation axis AR, below the horizontal bisection plane H, and below the opening edge 106 of the case body 4 (i.e., the upper end of the case body 4) (see FIG. 1). Further, the upper end 130u of the grip 130 and the upper end 142u of the grip 142 are positioned below the center of gravity G1 of the charger 2. In this embodiment, the center of gravity G1 of the charger 2 means the center of gravity of the charger 2 with the battery packs B attached in all of the eight battery receptacles 18 (see FIG. 3).

As shown in FIG. 17, when the left handle 124 is in the left upper position, a lower end 130s of the grip 130 is positioned above the handle rotation axis AL and above the horizontal bisection plane H, and the upper end 130u of the grip 130 is positioned above the opening edge 106 of the case body 4 (i.e., the upper end of the case body 4) (see FIG. 1). Similarly, when the right handle 136 is in the right upper position, a lower end 142s of the grip 142 is positioned above the handle rotation axis AR and above the horizontal bisection plane H, and the upper end 142u of the grip 142 is positioned above the opening edge 106 of the case body 4 (i.e., the upper end of the case body 4) (see FIG. 1). Further, the lower end 130s of the grip 130 and the lower end 142s of the grip 142 are positioned above the center of gravity G1 of the charger 2. In this embodiment, the center of gravity G1 of the charger 2 is constant in position regardless of the positions of the left handle 124 and the right handle 136. This is because changes in the positions of the left handle 124 and the right handle 136 do not substantially affect the position of the center of gravity G1 of the charger 2 since the weights of the left handle 124 and the right handle 136 are much lighter than the weight of the charger 2.

As shown in FIG. 14, when the left handle 124 is in the left upper position, a clearance 148 is defined between the outer surface of the grip 130 and the outer surfaces of the case body 4 and the lid 6. A width WL of the clearance 148 in the left-right direction is for example in a range from 25 mm to 55 mm, and in this embodiment, it is 28 mm. The width WL of the clearance 148 can be rephrased as the distance from the outer surface of the grip 130 to the outer surfaces of the case body 4 and the lid 6. Similarly, when the right handle 136 is in the right upper position, a clearance 150 is defined between the outer surface of the grip 142 and the outer surfaces of the case body 4 and the lid 6. A width WR of the clearance 150 in the left-right direction is for example in a range from 25 mm to 55 mm, and in this embodiment, it is 29 mm. The width WR of the clearance 150 can be rephrased as the distance from the outer surface of the grip 142 to the outer surfaces of the case body 4 and the lid 6

### Feet 154, 156, 158, 160

As shown in FIGS. 2 and 5, feet 154, 156, 158, 160 are located on the case body 4, and they project from the outer surface of the case body 4. The feet 154, 156, 158, 160 comprise a lower foot 154 located on the lower surface of the case body 4, a front foot 156 located on the front surface of the case body 4, a rear foot 158 located on the rear surface of the case body 4, and a left foot 160 located on the left surface of the case body 4. The lower foot 154 contacts the placement surface P when the charger 2 is placed on the placement surface P with the down direction of the charger 2 being coincident with the vertically downward direction. The front foot 156 contacts the placement surface P when the charger 2 is placed on the placement surface P with the front direction of the charger 2 being coincident with the vertically downward direction. The rear foot 158 contacts the placement surface P when the charger 2 is placed on the placement surface P with the rear direction of the charger 2 being coincident with the vertically downward direction. The left foot 160 contacts the placement surface P when the charger 2 is placed on the placement surface P with the left direction of the charger 2 being coincide with the vertically downward direction.

Among the feet 154, 156, 158, 160, the front foot 156, the rear foot 158, and the left foot 160 are coated with a rubber material (e.g., EPDM (ethylene propylene diene monomer rubber)). That is, the rubber material is used for a front contact portion 156c of the front foot 156 that is configured to contact the placement surface P, a rear contact portion 158c of the rear foot 158 that is configured to contact the placement surface P, and a left contact portion 160c of the left foot 160 that is configured to contact the placement surface P.

For example, when the charger 2 is on a stand or a shelf (i.e., somewhere above the ground) with the housing space S1 directed in the vertically upward direction, the user may have difficulty in accessing the housing space S1. However, as shown in FIG. 10, the charger 2 can be placed on the placement surface P with the rear foot 158 (see FIG. 2) being in contact with the placement surface P. Or, as shown in FIG. 11, the charger 2 can be placed on the placement surface P with the left foot 160 (see FIG. 2) being in contact with the placement surface P. Or, the charger 2 can be placed on the placement surface P with the front foot 156 being in contact with the placement surface P, although this is not shown. Orienting the charger 2 in any of the above allows the housing space S1 to direct in the horizontal direction and thus allows the user to easily access the housing space S1.

As shown in FIG. 16, the left end of the left handle 124 in the left lower position is positioned rightward of the left end of the left foot 160 (the left contact portion 160c). Thus, when the left foot 160 is in contact with the placement surface P, as shown in FIG. 11, with the left handle 124 being in the left lower position, the vertically lower end of the left handle 124 (the left end of the left handle 124 in FIG. 16) is positioned vertically above the vertically lower end of the left foot 160 (the left end of the left foot 160 in FIG. 16). This prevents the left handle 124 from contacting the placement surface P and thus prevents dirt (e.g., sand) on the placement surface P from adhering to the left handle 124.

### Multiple Connection of Chargers 2

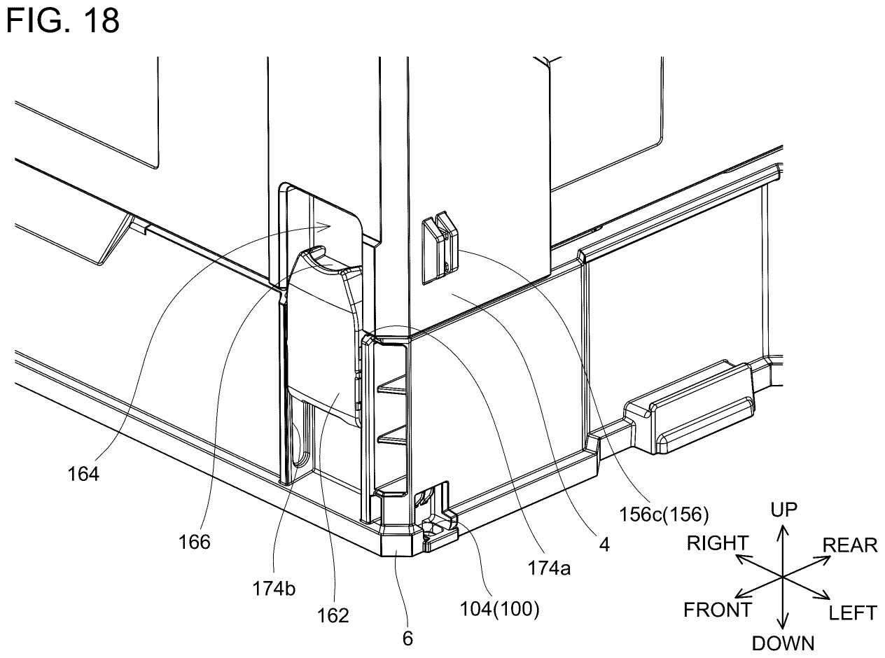

As shown in FIGS. 2 and 5, four engagement members 162 are located on the lid 6. Further, four engagement receivers 164 corresponding to the four engagement members 162 are located in a lower portion of the case body 4. As shown in FIG. 18, when the case body 4 of a charger 2 is on the lid 6 of another charger 2, the engagement receivers of the case body 4 are in engagement with the engagement members 162 of the lid 6. Specifically, when two chargers 2 are stacked on top of each other, the engagement members 162 of one charger 2 are engaged with the engagement receivers 164 of the other charger 2. The two chargers 2 can be connected to each other in this way.

Hereinafter, the engagement of the engagement members 162 with the engagement receivers 164 is described focusing on one engagement member 162 located on a left portion of the front surface of a lid 6 of a charger 2 (see FIG. 5) and one engagement receiver 164 located in a left portion of the front surface of a case body 4 of another charger 2 (see FIG. 5).

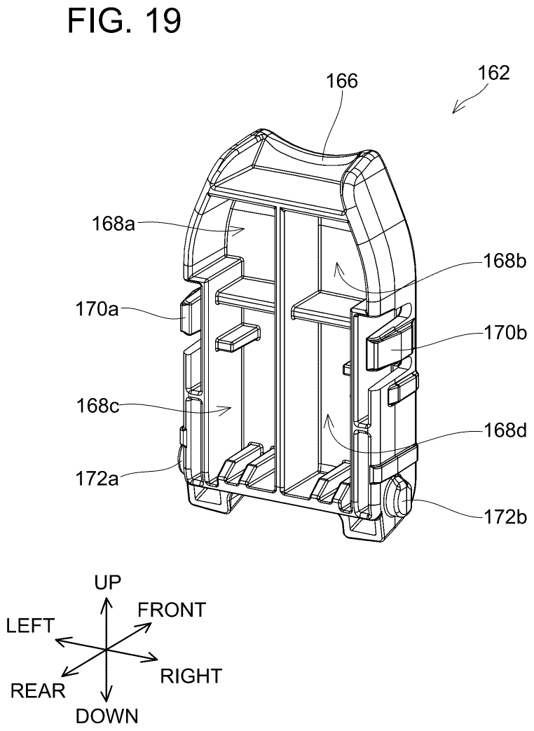

As shown in FIG. 19, the engagement member 162 comprises a manipulatable portion 166; cavities 168a, 168b, 168c, 168d; snaps 170a, 170b; and shafts 172a, 172b. The manipulatable portion 166 is located in an upper portion of the engagement member 162 and has a shape manipulatable by the user. The cavities 168a, 168b, 168c, 168d are recessed forward from the rear surface of the engagement member 162. The cavities 168a, 168b are adjacent to each other in the left-right direction and located below the manipulatable portion 166. The cavities 168c, 168d are adjacent to each other in the left-right direction and located below the cavities 168a, 168b. The snap 170a is located on a center portion of the left surface of the engagement member 162 and is elastically deformable in the left-right direction. The snap 170b is located on a center portion of the right surface of the engagement member 162 and is elastically deformable in the left-right direction. The shaft 172a is located on the left surface of the engagement member 162 and below the snap 170a, and projects leftward from the left surface of the engagement member 162. The shaft 172b is located on the right surface of the engagement member 162 and below the snap 170b, and projects rightward from the right surface of the engagement member 162.

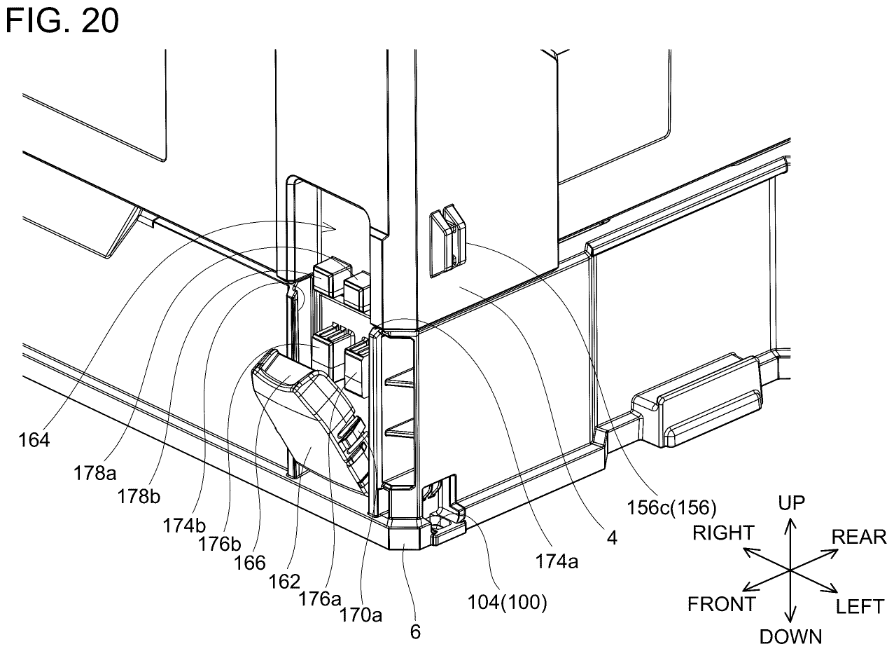

As shown in FIG. 20, grooves 174a, 174b are defined in the lid 6, and the grooves 174a, 174b are configured to receive the shafts 172a, 172b of the engagement member 162 (see FIG. 19) such that the shafts 172a, 172b are movable in the up-down direction and rotatable in their circumferential direction. Further, lid-side projections 176a, 176b are located on the lid 6, and the lid-side projections 176a, 176b are configured to be insertable into the cavities 168a, 168b, 168c, 168d of the engagement member 162. When the engagement member 162 is in its normal position (the position shown in FIG. 5), the lid-side projections 176a, 176b are in the cavities 168a, 168b (see FIG. 19). When the lid-side projections 176a, 176b are in the cavities 168a, 168b, the engagement member 162 is prohibited from moving in the up-down direction relative to the lid 6. Further, when the engagement member 162 is in the normal position (the position shown in FIG. 5), the snaps 170a, 170b of the engagement member 162 are engaged with the grooves 174a, 174b in a snap-fit manner. When a forward pulling force is applied to the manipulatable portion 166 of the engagement member 162 in the normal position, the snaps 170a, 170b are disengaged from the grooves 174a, 174b and the engagement member 162 is rotated about the shafts 172a, 172b. Thereby, the lid-side projections 176a, 176b are pulled out from the cavities 168a, 168b, as shown in FIG. 20, and the engagement member 162 is permitted to move in the up-down direction relative to the lid 6.

When the case body 4 is on the lid 6, the engagement receiver 164 is positioned above the engagement member 162. Case-side projections 178a, 178b are located on the engagement receiver 164, and the case-side projections 178a, 178b are configured to be insertable into the cavities 168a, 168b. When the case body 4 is on the lid 6, the case-side projections 178a, 178b can be aligned with the cavities 168a, 168b and the lid-side projections 176a, 176b can be aligned with the cavities 168c, 168d by moving the engagement member 162 in the up-down direction. When such moved engagement member 162 is pushed rearward, the case-side projections 178a, 178b are inserted into the cavities 168a, 168b, the lid-side projections 176a, 176b are inserted into the cavities 168c, 168d, and the snaps 170a, 170b engage with the grooves 174a, 174b in a snap-fit manner. As a result, as shown in FIG. 18, the engagement member 162 is engaged with the engagement receiver 164. When the manipulatable portion 166 is pulled forward, the snap-fit engagement of the snaps 170a, 170b with the grooves 174a, 174b is disengaged, the engagement member 162 is rotated about the shafts 172a, 172b, and the case-side projections 178a, 178b and the lid-side projections 176a, 176b are pulled out from the cavities 168a, 168b, 168c, 168d. The engagement member 162 is thereby disengaged from the engagement receiver 164.

### Second Embodiment: Charger 202

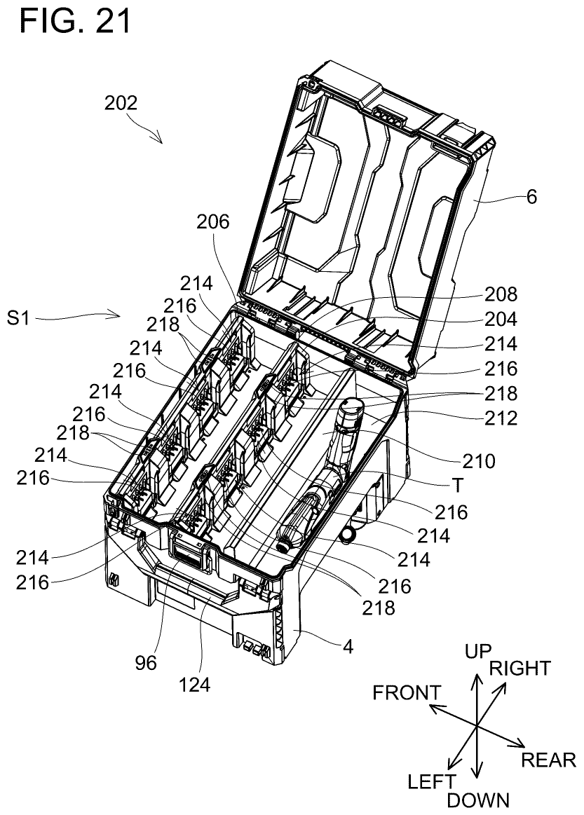

A charger 202 shown in FIG. 21 is different from the charger 2 according to the first embodiment (see FIG. 1) in that it includes a tray member 204 instead of the tray member 10 (see FIG. 4). The other components of the charger 202 are substantially the same as those of the charger 2 according to the first embodiment. The following description focuses on the tray member 204.

The tray member 204 comprises a first wall 206, a second wall 208, a third wall 210, and a bottom wall 212. The first wall 206 extends in the up-down direction and the left-right direction along the front wall of the case body 4. The second wall 208 is located rearward of the first wall 206 and extends in the up-down direction and the left-right direction. The third wall 210 is located rearward of the second wall 208 and extends in the up-down direction and left-right direction. As with the bottom wall 16 of the tray member 10 in the first embodiment (see FIG. 4), the bottom wall 212 is separated from the bottom wall of the case body 4 and extends in the front-rear direction and the left-right direction. Eight battery receptacles 214, eight connection terminals 216, and eight charging state displays 218 are located on the tray member 204. Four battery receptacles 214 are located on the rear surface of the first wall 206 and the other four battery receptacles 214 are located on the rear surface of the second wall 208. Each connection terminal 216 and each charging state display 218 are assigned to corresponding one of the battery receptacles 214. Configurations of the battery receptacles 214, the connection terminals 216, and the charging state displays 218 are substantially the same as those of the battery receptacles 18, the connection terminals 26, and the charging state displays 28 in the first embodiment (see FIG. 3), and thus detailed descriptions for them are omitted here. A part of the housing space S1 that is located rearward of the third wall 210 is a substantially cuboid space. This space can house, for example, a manual tool, a power tool, and/or an accessary of a power tool. In the example shown in FIG. 21, a power tool Tis housed in the part of the housing space S1 located rearward of the third wall 210.

### Variants

The charger 2 (the charger 202) may be configured to supply electric power supplied from the battery packs B to an external via the external terminal 8. That is, the charger 2 (the charger 202) may function as a power supply device configured to supply electric power to an external.

The charger 2 (the charger 202) may comprise an operation unit configured to perform a predetermined operation (e.g., heating, retaining heat, cooling) using electric power supplied from the battery packs B. For example, the charger 2 (the charger 202) may function as a microwave, a warmer, or a refrigerator.

The charger 2 (the charger 202) may not comprise the external terminal 8, the tray member 10 (the tray member 204), nor the control board 32. In this case, the charger 2 (the charger 202) may function as a carrying case used to carry an object.

The battery receptacles 18 may be located on the outer surface of the case body 4. In this case, the battery packs B may be detachably attached to the outer surface of the case body 4.

The arrangement and/or orientation of the battery receptacles 18 (the battery receptacles 214) on the tray member 10 (the tray member 204) may be varied. In this case, the directions in which the battery packs B are slid for attachment to and detachment from the battery receptacles 18 (the battery receptacles 214) may be directions inclined to the up-down direction (e.g., the front-rear direction, the left-right direction).

The case body 4 may have a shape different from the substantially cuboid shape (e.g., a substantially cylindrical shape, a substantially hexagonal-column shape)

The case body 4 and the lid 6 may be slidably coupled to each other. For example, a long hole extending in the left-right direction may be defined in the lid 6, and the first coupling pin 40 and the second coupling pin 46 may be inserted in the long hole. Within the long hole, the first coupling pin 40 and the second coupling pin 46 are slidable in the left-right direction, so that the lid 6 is slidable in the left-right direction relative to the case body 4. In this case as well, the lid 6 may be disengaged from the case body 4 by detaching the first coupling pin 40 and the second coupling pin 46 from the case body 4.

(See FIG. 6.) The finger pad 60 and/or the wall 62 may be aligned with the first coupling pin 40 in the front-rear direction (the axial direction of the first coupling pin 40). The finger pad 74 and/or the wall 76 may be aligned with the second coupling pin 46 in the front-rear direction (the axial direction of the second coupling pin 46).

(See FIG. 6.) The guide 80 and the engagement pieces 86, 90 may be located on the lid 6 instead of the case body 4. That is, the first coupling member 36 (the second coupling member 38) may be attached to the lid 6 instead of the case body 4. In this case, the blocking projection 94 may be located on the case body 4.

(See FIG. 6.) The guide 80 and the engagement pieces 86, 90 may be located on the inner surface of the case body 4 (inside of the housing space S1) instead of the outer surface of the case body 4. That is, the first coupling member 36 (the second coupling member 38) may be attached to the inner surface of the case body 4 (inside of the housing space S1) instead of the outer surface of the case body 4.

(See FIG. 5.) The lid 6 may not comprise the blocking projection 94. In this case, the first coupling member 36 (the second coupling member 38) may be permitted to move between the first coupling position (the second coupling position) and the first decoupled position (the second decoupling position) regardless of the opening degree of the lid 6.

(See FIG. 6.) The first coupling member 36 (the second coupling member 38) may not comprise the engagement rib 64 (the engagement rib 78). The first coupling member 36 (the second coupling member 38) may not comprise the finger pad 60 (the finger pad 74). The first coupling member 36 (the second coupling member 38) may not comprise the wall 62 (the wall 76)

(See FIGS. 2 and 5.) The positional change of the grip 130 of the left handle 124 (the grip 142 of the right handle 136) may not be implemented by rotatably mounting the left handle 124 (the right handle 136) on the case body 4 and may be implemented by other means. For example, the positional change of the grip 130 of the left handle 124 (the grip 142 of the right handle 136) may be implemented by slidably mounting the left handle 124 (the right handle 136) on the case body 4. Alternatively, the positional change of the grip 130 of the left handle 124 (the grip 142 of the right handle 136) may be implemented by the arms 126, 128 of the left handle 124 (the arms 138, 140 of the right handle 136) including an extendable mechanism (e.g., a telescopic mechanism).

(See FIGS. 16 and 17.) The arrangement and/or shape of the left handle 124 may be varied. In this case, the handle rotation axis AL of the left handle 124 may be positioned below the horizontal bisection plane H. When the left handle 124 is in the left upper position, the lower end 130s of the grip 130 may be positioned below the handle rotation axis AL. When the left handle 124 is in the left upper position, the lower end 130s of the grip 130 may be positioned below the horizontal bisection plane H. When the left handle 124 is in the left upper position, the upper end 130u of the grip 130 may be positioned below the opening edge 106 of the case body 4 (i.e., the upper end of the case body 4) (see FIG. 1). The width WL of the clearance 148 may be smaller than 25 mm or larger than 55 mm.

(See FIGS. 16 and 17.) The arrangement and/or shape of the right handle 136 may be varied. In this case, the handle rotation axis AR of the right handle 136 may be positioned below the horizontal bisection plane H. When the right handle 136 is in the right upper position, the lower end 142s of the grip 142 may be positioned below the handle rotation axis AR. When the right handle 136 is in the right upper position, the lower end 142s of the grip 142 may be positioned below the horizontal bisection plane H. When the right handle 136 is in the right upper position, the upper end 142u of the grip 142 may be positioned below the opening edge 106 of the case body 4 (i.e., the upper end of the case body 4) (see FIG. 1). The width WR of the clearance 150 may be smaller than 25 mm or larger than 55 mm.

When the left handle 124 is in the left upper position and the right handle 136 is in the right upper position, the lower end 130s of the grip 130 and the lower end 142s of the grip 142 both may be positioned below the center of gravity G1 of the charger 2 (the charger 202).

(See FIGS. 2 and 5.) The charger 2 (the charger 202) may not comprise the front foot 156 and/or the rear foot 158.

(See FIGS. 2 and 5.) The front foot 156, the rear foot 158, and/or the left foot 160 may not be coated with the rubber material. That is, the same material as that of the case body 4 (e.g., PC+ABS) may be used for the front foot 156, the rear foot 158, and/or the left foot 160.

(See FIGS. 2 and 5.) The front foot 156, the rear foot 158, and/or the left foot 160 may be different from those described in connection with the first and second embodiments. For example, the front foot 156, the rear foot 158, and/or the left foot 160 may be sheets that are constituted of a rubber material (i.e., rubber sheets) and attached to the outer surface of the case body 4. Alternatively, the front foot 156, the rear foot 158, and/or the left foot 160 may be blocks that are constituted of a rubber material and inserted to the case body 4. Alternatively, the front foot 156, the rear foot 158, and/or the left foot 160 may be blocks that are constituted of a rubber material and screwed to the case body 4.

(See FIG. 5.) The charger 2 (the charger 202) may not comprise the right handle 136. In this case, the user can carry the charger 2 (the charger 202) grasping the left handle 124 with one hand (or both hands).

### Features of Embodiments

In one or more embodiments, the charger 2, 202 (an example of electrical device) comprises the case body 4 defining the housing space S1, the battery receptacles 18, 214 disposed on the case body 4, wherein the battery packs B used as power supplies for a power tool is attached to the battery receptacles 18, 214, the external terminal 8 disposed on the case body 4 and configured to be electrically connected to the battery packs B via the battery receptacles 18, 214, the left handle 124 disposed on the left surface of the case body 4 and comprising the grip 130 (an example of left grip) configured to be grasped by the user, and the right handle 136 disposed on the right surface of the case body 4 and comprising the grip 142 (an example of right grip) configured to be grasped by the user. The left handle 124 is configured to be movable relative to the case body 4 between the left lower position and the left upper position. The position of the grip 130 when the left handle 124 is in the left upper position is higher than the position of the grip 130 when the left handle 124 is in the left lower position. The right handle 136 is configured to be movable relative to the case body 4 between the right lower position and the right upper position. The position of the grip 142 when the right handle 136 is in the right upper position is higher than the position of the grip 142 when the right handle 136 is in the right lower position.

When the grip 130 (the grip 142) is positioned relatively high relative to the case body 4, the user can stably carry the charger 2, 202 grasping the grip 130 (the grip 142) because the center of gravity of the charger 2, 202 is low. When the grip 130 (the grip 142) is positioned relatively high relative to the case body 4, however, the grip 130 (the grip 142) may stand in the way for the user to remove/put an object from/into the housing space S1. According to the configuration above, the user can change the position of the grip 130 (the grip 142) relative to the case body 4 in the up-down direction. For example, when the user is about to carry the charger 2, 202, the user can move the grip 130 (the grip 142) relative to the case body 4 to a relatively high position, so that the user can stably carry the charger 2, 202. Further, when the user is about to remove/put an object from/into the housing space S1, the user can move the grip 130 (the grip 142) relative to the case body 4 to a relatively low position, so that the grip 130 (the grip 142) does not stand in the way for the user's action. Thus, the configuration above improves the convenience of the charger 2, 202.

In one or more embodiments, the left handle 124 is configured to be rotatable relative to the case body 4 about the handle rotation axis AL (an example of left handle rotation axis) between the left lower position and the left upper position. When the left handle 124 is in the left lower position, the upper end 130u of the grip 130 is positioned below the handle rotation axis AL. When the left handle 124 is in the left upper position, the lower end 130s of the grip 130 is positioned above the handle rotation axis AL. The right handle 136 is configured to be rotatable relative to the case body 4 about the handle rotation axis AR (an example of right handle rotation axis) between the right lower position and the right upper position. When the right handle 136 is in the right lower position, the upper end 142u of the grip 142 is positioned below the handle rotation axis AR. When the right handle 136 is in the right upper position, the lower end 142s of the grip 142 is positioned above the handle rotation axis AR.

If the upper end 130u of the grip 130 (the upper end 142u of the grip 142) cannot be moved above the handle rotation axis AL (the handle rotation axis AR), the center of gravity of the charger 2, 202 may not be sufficiently lowered when the user carries it, which may hinder the user from stably carrying the charger 2, 202. According to the configuration above, the upper end 130u of the grip 130 (the upper end 142u of the grip 142) can be positioned to above the handle rotation axis AL (the handle rotation axis AR), and thus the center of gravity of the charger 2, 202 is sufficiently lowered when the user carries it. Thus, the user can stably carry the charger 2, 202.

In one or more embodiments, the handle rotation axes AL and AR are positioned above the horizontal bisection plane H that bisects the charger 2, 202 in the up-down direction.

If the handle rotation axis AL (the handle rotation axis AR) is positioned below the horizontal bisection plane H, the left handle 124 (the right handle 136) is mounted on the case body 4 at a relatively low position. Therefore, the center of gravity of the charger 2, 202 is not sufficiently lowered when the user carries it, and thus the user may not stably carry the charger 2, 202. According to the configuration above, the handle rotation axis AL (the handle rotation axis AR) is positioned above the horizontal bisection plane H, and thus the left handle 124 (the right handle 136) is mounted on the case body 4 at a relatively high position. Therefore, the center of gravity of the charger 2, 202 is sufficiently lowered when the user carries it, and thus the user can stably carry the charger 2, 202.

In one or more embodiments, when the left handle 124 is in the left upper position, the lower end 130s of the grip 130 is positioned above the horizontal plane that bisects the charger 2, 202 in the up-down direction. When the right handle 136 is in the right upper position, the lower end 142s of the grip 142 is positioned above the horizontal plane that bisects the charger 2, 202 in the up-down direction.

If the lower end 130s of the grip 130 (the lower end 142s of the grip 142) cannot be moved above the horizontal bisection plane H, the center of gravity of the charger 2, 202 may not be sufficiently lowered when the user carries it, which may hinder the user from stably carrying the charger 2, 202. According to the configuration above, the lower end 130s of the grip 130 (the lower end 142s of the grip 142) can be positioned to above the horizontal bisection plane H, and thus the center of gravity of the charger 2, 202 is sufficiently lowered when the user carries it. Thus, the user can stably carry the charger 2, 202.

In one or more embodiments, the housing space S1 of the case body 4 is open upward. The charger 2, 202 further comprises the lid 6 disposed at an upper portion of the case body 4 and configured to open and close the housing space S1. When the left handle 124 is in the left upper position, the upper end 130u of the grip 130 is positioned above the opening edge 106 (the upper end) of the case body 4. When the right handle 136 is in the right upper position, the upper end 142u of the grip 142 is positioned above the opening edge 106 (the upper end) of the case body 4.

If the upper end 130u of the grip 130 (the upper end 142u of the grip 142) cannot be moved above the opening edge 106 (the upper end) of the case body 4, the center of gravity of the charger 2, 202 may not be sufficiently lowered when the user carries it, which may hinder the user from stably carrying the charger 2, 202. According to the configuration above, the upper end 130u of the grip 130 (the upper end 142u of the grip 142) can be positioned to above the opening edge 106 (the upper end) of the case body 4, and thus the center of gravity of the charger 2, 202 is sufficiently lowered when the user carries it. Thus, the user can stably carry the charger 2, 202.

In one or more embodiments, when the left handle 124 is in the left upper position, the width WL of the clearance 148 in the left-right direction (the distance between the outer surface of the case body 4 and the outer surface of the grip 130) is 25 mm or more. When the right handle 136 is in the right upper position, the width WR of the clearance 150 in the left-right direction (the distance between the outer surface of the case body 4 and the outer surface of the grip 142) is 25 mm or more.

If a user's hand grasping the grip 130 (the grip 142) contacts the outer surface of the case body 4, the user may thereby feel uncomfortable. According to the configuration above, the clearance 148 (the clearance 150) that is sufficiently larger than the thickness of the user's hand is secured between the outer surface of the case body 4 and the outer surface of the grip 130 (the grip 142). This clearance suppresses the user's hand grasping the grip 130 (the grip 142) from contacting the outer surface of the case body 4 and thus prevents the user from feeling uncomfortable.

In one or more embodiments, the charger 2, 202 further comprises the lid 6 configured to be movable relative to the case body 4 between the open position where the lid 6 opens the housing space S1 and the closed position where the lid 6 closes the housing space S1. When the lid 6 is in the closed position and the left handle 124 is in the left upper position, the width WL of the clearance 148 in the left-right direction (the distance between the outer surface of the lid 6 and the outer surface of the grip 130) is 25 mm or more. When the lid 6 is in the closed position and the right handle 136 is in the right upper position, the width WR of the clearance 150 in the left-right direction (the distance between the outer surface of the lid 6 and the outer surface of the grip 142) is 25 mm or more.

If a user's hand grasping the grip 130 (the grip 142) contacts the outer surface of the lid 6, the user may thereby feel uncomfortable. According to the configuration above, the clearance 148 (the clearance 150) that is sufficiently larger than the thickness of the user's hand is secured between the outer surface of the lid 6 and the outer surface of the grip 130 (the grip 140). This clearance suppresses the user's hand grasping the grip 130 (the grip 142) from contacting the outer surface of the lid 6 and thus prevents the user from feeling uncomfortable.

In one or more embodiments, when the left handle 124 is in the left upper position and the right handle 136 is in the right upper position, the lower end 130s of the grip 130 and the lower end 142s of the grip 142 are positioned above the center of gravity G1 of the charger 2, 202 with the battery packs B attached to the battery receptacles 18.

If the lower end 130s of the grip 130 (the lower end 142s of the grip 142) cannot be moved above the center of gravity G1 of the charger 2, the center of gravity G1 of the charger 2, 202 may not be sufficiently lowered when the user carries it, which may hinder the user from stably carrying the charger 2. According to the configuration above, the lower end 130s of the grip 130 (the lower end 142s of the grip 142) can be positioned to above the center of gravity G1 of the charger 2, and thus the center of gravity G1 of the charger 2 is sufficiently lowered when the user carries it. Thus, the user can stably carry the charger 2.

In one or more embodiments, the case body 4 has a substantially cuboid shape having its short direction along the front-rear direction and its longitudinal direction along the left-right direction.

For example, a user may carry the charger 2, 202 alone by grasping the grip 130 with one hand and grasping the grip 142 with the other hand, and in this case, the case body 4 is positioned in front of the torso of the user. Thus, if the longitudinal direction of the case body 4 is along the front-rear direction, the user may not carry the charger 2, 202 comfortably. By contrast, according to the configuration above, the case body 4 has its short direction along the front-rear direction. This allows the user to carry the charger 2, 202 comfortably.

In one or more embodiments, the battery receptacles 18, 214 are disposed in the housing space S1.

If the battery receptacles 18, 214 are disposed outside the housing space S1 (e.g., on the outer surface of the case body 4), the battery packs B attached in the battery receptacles 18, 214 are exposed to the outside of the housing space S1. In this case, the battery packs B may bump an object (e.g., a tool, ground, a wall, etc.) and thereby be damaged. According to the configuration above, the battery receptacles 18, 214 are disposed in the housing space S1, and this prevents the battery packs B attached in the battery receptacles 18, 214 from being exposed to the outside of the housing space S1. Thus, the battery packs B are prevented from bumping an object and being damaged.

In one or more embodiments, the housing space S1 of the case body 4 is open upward. The charger 2, 202 further comprises the lid 6 disposed at an upper portion of the case body 4 and configured to open and close the housing space S1. The battery packs B are attached to the battery receptacles 18, 214 by being slid along the up-down direction relative to the battery receptacles 18, 214.

The configuration above facilitates attachment/detachment of the battery packs B to/from the battery receptacles 18, 214.

In one or more embodiments, the charger 2, 202 (an example of carrying case) is configured to allow a user to carry at least one of a manual tool, a power tool, and the battery packs B used as power supplies for a power tool. The charger 2, 202 comprises the case body 4 defining the housing space S1, the left handle 124 disposed on the left surface of the case body 4 and comprising the grip 130 configured to be grasped by the user, and the right handle 136 disposed on the right surface of the case body 4 and comprising the grip 142 configured to be grasped by the user. The left handle 124 is configured to be rotatable relative to the case body 4 about the handle rotation axis AL (an example of left handle rotation axis) between the left lower position and the left upper position. The position of the grip 130 when the left handle 124 is in the left upper position is higher than the position of the grip 130 when the left handle 124 is in the left lower position. When the left handle 124 is in the left lower position, the upper end 130u of the grip 130 is positioned below the handle rotation axis AL. When the left handle 124 is in the left upper position, the lower end 130s of the grip 130 is positioned above the handle rotation axis AL. The right handle 136 is configured to be rotatable relative to the case body 4 about the handle rotation axis AR (an example of right handle rotation axis) between the right lower position and the right upper position. The position of the grip 142 when the right handle 136 is in the right upper position is higher than the position of the grip 142 when the right handle 136 is in the right lower position. When the right handle 136 is in the right lower position, the upper end 142u of the grip 142 is positioned below the handle rotation axis AR. When the right handle 136 is in the right upper position, the lower end 142s of the grip 142 is positioned above the handle rotation axis AR.

When the grip 130 (the grip 142) is positioned relatively high relative to the case body 4, the user can stably carry the charger 2, 202 grasping the grip 130 (the grip 142) because the center of gravity of the charger 2, 202 is low. When the grip 130 (the grip 142) is positioned relatively high relative to the case body 4, however, the grip 130 (the grip 142) may stand in the way for the user to remove/put an object from/into the housing space S1. According to the configuration above, the user can change the position of the grip 130 (the grip 142) relative to the case body 4 in the up-down direction. For example, when the user is about to carry the charger 2, 202, the user can move the grip 130 (the grip 142) relative to the case body 4 to a relatively high position, so that the user can stably carry the charger 2, 202. Further, when the user is about to remove/put an object from/into the housing space S1, the user can move the grip 130 (the grip 142) relative to the case body 4 to a relatively low position, so that the grip 130 (the grip 142) does not stand in the way for the user's action. Thus, the configuration above improves the convenience of the charger 2, 202. Further, in the configuration above, the upper end 130u of the grip 130 (the upper end 142u of the grip 142) can be positioned to above the handle rotation axis AL (the handle rotation axis AR), which allows the center of gravity of the charger 2, 202 to be positioned sufficiently low when the user carries it. Thus, the user can stably carry the charger 2, 202.

In one or more embodiments, the charger 2, 202 further comprises the battery receptacles 18, 214 disposed on the case body 4. The battery packs B are attached to the battery receptacles 18, 214.

The configuration above allows for positioning of the battery packs B to the charger 2, 202 by attaching the battery packs B to the battery receptacles 18, 214.

In one or more embodiments, the charger 2, 202 (an example of electrical device) comprises the case body 4 defining the housing space S1; the battery receptacles 18, 214 disposed on the case body 4, wherein the battery packs B used as power supplies for a power tool are attached to the battery receptacles 18, 214; the external terminal 8 disposed on the case body 4 and configured to be electrically connected to the battery packs B via the battery receptacles 18, 214; the left surface (an example of first surface) which is a side surface of the case body 4; the left handle 124 (an example of first handle) disposed on the left surface; and the left foot 160 (an example of first foot) disposed on the left surface. The left handle 124 is movable relative to the case body 4 between the left lower position (an example of retracted position) where the left handle 124 extends along the left surface and the left upper position (an example of deployed position) where the left handle 124 extends at an angle to the left surface. The charger 2, 202 is configured to be placed on the placement surface P such that the left surface is directed toward the placement surface P, by bringing the left foot 160 into contact with the placement surface P. When the left handle 124 is in the left lower position and the charger 2, 202 is on the placement surface P with the left foot 160 being in contact with the placement surface P, the vertically lower end of the left handle 124 is positioned above the vertical lower end (the left contact portion 160c) of the left foot 160.

In some cases, the charger 2, 202 may be placed on the placement surface P with the left surface of the case body 4 directed toward the placement surface P. In this case, if the left handle 124 disposed on the left surface contacts the placement surface P, dirt (e.g., sand) on the placement surface P may adhere to the left handle 124. According to the configuration above, when the charger 2, 202 is placed on the placement surface P with the left surface of the case body 4 directed toward the placement surface P, the vertically lower end of the left handle 124 is positioned above the vertically lower end (the left contact portion 160c) of the left foot 160 which is in contact with the placement surface P. This prevents the left handle 124 from contacting the placement surface P, and thus prevents the dirt on the placement surface P from adhering to the left handle 124.

In one or more embodiments, the left handle 124 is configured to be rotatable about the handle rotation axis AL (an example of first handle rotation axis) relative to the case body 4 between the left lower position and the left upper position.

The configuration above allows the left handle 124 to move between the left lower position and the left upper position in a simple manner.

In one or more embodiments, the left foot 160 comprises the left contact portion 160c configured to contact the placement surface P. A rubber material is used for the left contact portion 160c.

In the configuration above, when the charger 2, 202 is placed on the placement surface P with the left foot 160 (the left contact portion 160c) contacting the placement surface P, the friction resistance between the left foot 160 (the left contact portion 160c) and the placement surface P is relatively large. This suppresses changes in the position of the charger 2, 202 on the placement surface P even when an impact and/or vibration is applied to the charger 2, 202.

In one or more embodiments, the charger 2, 202 further comprises the right surface (an example of second surface) which is a side surface of the case body 4 and faces in the opposite direction to the direction in which the left surface faces; and the right handle 136 (an example of second handle) disposed on the right surface.

The configuration above allows the user to carry the charger 2, 202 by grasping the left handle 124 with one hand and grasping the right handle 136 with the other hand. Thus, the user can carry the charger 2, 202 easily.

In one or more embodiments, the charger 2, 202 further comprises the front surface (the rear surface) (an example of third surface) which is a side surface of the case body 4 and different from the left surface and the right surface; and the front foot 156 (the rear foot 158) (an example of second foot) disposed on the front surface (the rear surface). The charger 2, 202 is configured to be placed on the placement surface P such that the front surface (the rear surface) is directed toward the placement surface P, by bringing the front foot 156 (the rear foot 158) into contact with the placement surface P.

The configuration above allows the charger 2, 202 to be placed on the placement surface P with the surface on which neither of the left handle 124 nor the right handle 136 is disposed (i.e., the front surface or the rear surface) directed toward the placement surface P.

In one or more embodiments, the charger 2, 202 is a carrying case configured to allow the user to carry at least one of a manual tool, a power tool, and the battery packs B used as power supplies for a power tool. The charger 2, 202 comprises the case body 4 defining the housing space S1; the left surface (an example of first surface) which is a side surface of the case body 4; the left handle 124 (an example of first handle) disposed on the left surface; and the left foot 160 (an example of first foot) disposed on the left surface. The left handle 124 is movable relative to the case body 4 between the left lower position (an example of retracted position) where the left handle 124 extends along the left surface and the left upper position (an example of deployed position) where the left handle 124 extends at an angle to the left surface. The charger 2, 202 is configured to be placed on the placement surface P such that the left surface is directed toward the placement surface P, by bringing the left foot 160 into contact with the placement surface P. When the left handle 124 is in the left lower position and the charger 2, 202 is on the placement surface P with the left foot 160 being in contact with the placement surface P, the vertically lower end of the left handle 124 is positioned above the vertically lower end (the left contact portion 160c) of the left foot 160.

In some cases, the charger 2, 202 may be placed on the placement surface P with the left surface of the case body 4 directed toward the placement surface P. In this case, if the left handle 124 disposed on the left surface contacts the placement surface P, dirt (e.g., sand) on the placement surface P may adhere to the left handle 124. According to the configuration above, when the charger 2, 202 is placed on the placement surface P with the left surface of the case body 4 directed toward the placement surface P, the vertically lower end of the left handle 124 is positioned above the vertically lower end (he left contact portion 160c) of the left foot 160 which is in contact with the placement surface P. This prevents the left handle 124 from contacting the placement surface P, and thus prevents the dirt on the placement surface P from adhering to the left handle 124.

What is claimed is:

1. An electrical device comprising:
a case body defining a housing space;
a battery receptacle disposed on the case body, wherein a battery pack used as a power supply for a power tool is attached to the battery receptacle;
an external terminal disposed on the case body and configured to be electrically connected to the battery pack via the battery receptacle;
a left handle disposed on a left surface of the case body and comprising a left grip configured to be grasped by a user; and
a right handle disposed on a right surface of the case body and comprising a right grip configured to be grasped by the user,
wherein
the left handle is configured to be movable relative to the case body between a left lower position and a left upper position,
a position of the left grip when the left handle is in the left upper position is higher than a position of the left grip when the left handle is in the left lower position,
the right handle is configured to be movable relative to the case body between a right lower position and a right upper position, and
a position of the right grip when the right handle is in the right upper position is higher than a position of the right grip when the right handle is in the right lower position.

2. The electrical device according to claim 1, wherein
the left handle is configured to be rotatable relative to the case body about a left handle rotation axis between the left lower position and the left upper position,
when the left handle is in the left lower position, an upper end of the left grip is positioned below the left handle rotation axis,
when the left handle is in the left upper position, a lower end of the left grip is positioned above the left handle rotation axis,
the right handle is configured to be rotatable relative to the case body about a right handle rotation axis between the right lower position and the right upper position,
when the right handle is in the right lower position, an upper end of the right grip is positioned below the right handle rotation axis, and
when the right handle is in the right upper position, a lower end of the right grip is positioned above the right handle rotation axis.

3. The electrical device according to claim 2, wherein
the left handle rotation axis and the right handle rotation axis are positioned above a horizontal plane that bisects the electrical device in an up-down direction.

4. The electrical device according to claim 1, wherein
when the left handle is in the left upper position, a lower end of the left grip is positioned above a horizontal plane that bisects the electrical device in an up-down direction, and
when the right handle is in the right upper position, a lower end of the right grip is positioned above the horizontal plane that bisects the electrical device in the up-down direction.

5. The electrical device according to claim 1, wherein
the housing space of the case body is open upward,
the electrical device further comprises a lid disposed at an upper portion of the case body and configured to open and close the housing space,
when the left handle is in the left upper position, an upper end of the left grip is positioned above an upper end of the case body, and
when the right handle is in the right upper position, an upper end of the right grip is positioned above the upper end of the case body.

6. The electrical device according to claim 1, wherein
when the left handle is in the left upper position, a distance between an outer surface of the case body and an outer surface of the left grip is 25 mm or more, and
when the right handle is in the right upper position, a distance between the outer surface of the case body and an outer surface of the right grip is 25 mm or more.

7. The electrical device according to claim 1, further comprising a lid configured to be movable relative to the case body between an open position where the lid opens the housing space and a closed position where the lid closes the housing space,
wherein
when the lid is in the closed position and the left handle is in the left upper position, a distance between an outer surface of the lid and an outer surface of the left grip is 25 mm or more, and
when the lid is in the closed position and the right handle is in the right upper position, a distance between the outer surface of the lid and an outer surface of the right grip is 25 mm or more.

8. The electrical device according to claim 1, wherein
when the left handle is in the left upper position and the right handle is in the right upper position, a lower end of the left grip and a lower end of the right grip are positioned above a center of gravity of the electrical device with the battery pack attached to the battery receptacle.

9. The electrical device according to claim 1, wherein
the case body has a substantially cuboid shape having a short direction along a front-rear direction and a longitudinal direction along a left-right direction.

10. The electrical device according to claim 1, wherein
the battery receptacle is disposed in the housing space.

11. The electrical device according to claim 10, wherein
the housing space of the case body is open upward,
the electrical device further comprises a lid disposed at an upper portion of the case body and configured to open and close the housing space, and
the battery pack is attached to the battery receptacle by being slid along an up-down direction relative to the battery receptacle.

12. A carrying case configured to allow a user to carry at least one of a manual tool, a power tool, and a battery pack used as a power supply for a power tool, the carrying case comprising:
a case body defining a housing space;
a left handle disposed on a left surface of the case body and comprising a left grip configured to be grasped by the user; and
a right handle disposed on a right surface of the case body and comprising a right grip configured to be grasped by the user,
wherein
the left handle is configured to be rotatable relative to the case body about a left handle rotation axis between a left lower position and a left upper position,
a position of the left grip when the left handle is in the left upper position is higher than a position of the left grip when the left handle is in the left lower position,
when the left handle is in the left lower position, an upper end of the left grip is positioned below the left handle rotation axis,
when the left handle is in the left upper position, a lower end of the left grip is positioned above the left handle rotation axis,
the right handle is configured to be rotatable relative to the case body about a right handle rotation axis between a right lower position and a right upper position,
a position of the right grip when the right handle is in the right upper position is higher than a position of the right grip when the right handle is in the right lower position,
when the right handle is in the right lower position, an upper end of the right grip is positioned below the right handle rotation axis, and
when the right handle is in the right upper position, a lower end of the right grip is positioned above the right handle rotation axis.

13. The carrying case according to claim 12, further comprising a battery receptacle disposed on the case body, wherein the battery pack is attached to the battery receptacle.

14. The electrical device according to claim 3, wherein
when the left handle is in the left upper position, a lower end of the left grip is positioned above the horizontal plane that bisects the electrical device in the up-down direction,
when the right handle is in the right upper position, a lower end of the right grip is positioned above the horizontal plane that bisects the electrical device in the up-down direction,
the housing space of the case body is open upward,
the electrical device further comprises a lid disposed at an upper portion of the case body and configured to be movable relative to the case body between an open position where the lid opens the housing space and a closed position where the lid closes the housing space,
when the left handle is in the left upper position, an upper end of the left grip is positioned above an upper end of the case body,
when the right handle is in the right upper position, an upper end of the right grip is positioned above the upper end of the case body,
when the left handle is in the left upper position, a distance between an outer surface of the case body and an outer surface of the left grip is 25 mm or more,
when the right handle is in the right upper position, a distance between the outer surface of the case body and an outer surface of the right grip is 25 mm or more,
when the lid is in the closed position and the left handle is in the left upper position, a distance between an outer surface of the lid and the outer surface of the left grip is 25 mm or more,
when the lid is in the closed position and the right handle is in the right upper position, a distance between the outer surface of the lid and the outer surface of the right grip is 25 mm or more,
when the left handle is in the left upper position and the right handle is in the right upper position, a lower end of the left grip and a lower end of the right grip are positioned above a center of gravity of the electrical device with the battery pack attached to the battery receptacle,
the case body has a substantially cuboid shape having a short direction along a front-rear direction and a longitudinal direction along a left-right direction,
the battery receptacle is disposed in the housing space, and
the battery pack is attached to the battery receptacle by being slid along the up-down direction relative to the battery receptacle.

15. The carrying case according to claim 13, wherein
the left handle rotation axis and the right handle rotation axis are positioned above a horizontal plane that bisects the carrying case in an up-down direction,
when the left handle is in the left upper position, a lower end of the left grip is positioned above the horizontal plane that bisects the carrying case in the up-down direction,
when the right handle is in the right upper position, a lower end of the right grip is positioned above the horizontal plane that bisects the carrying case in the up-down direction,
the housing space of the case body is open upward,
the carrying case further comprises a lid disposed at an upper portion of the case body and configured to be movable relative to the case body between an open position where the lid opens the housing space and a closed position where the lid closes the housing space,
when the left handle is in the left upper position, an upper end of the left grip is positioned above an upper end of the case body,
when the right handle is in the right upper position, an upper end of the right grip is positioned above the upper end of the case body,
when the left handle is in the left upper position, a distance between an outer surface of the case body and an outer surface of the left grip is 25 mm or more,
when the right handle is in the right upper position, a distance between the outer surface of the case body and an outer surface of the right grip is 25 mm or more,
when the lid is in the closed position and the left handle is in the left upper position, a distance between an outer surface of the lid and the outer surface of the left grip is 25 mm or more,
when the lid is in the closed position and the right handle is in the right upper position, a distance between the outer surface of the lid and the outer surface of the right grip is 25 mm or more,
when the left handle is in the left upper position and the right handle is in the right upper position, a lower end of the left grip and a lower end of the right grip are positioned above a center of gravity of the carrying case with the battery pack attached to the battery receptacle,
the case body has a substantially cuboid shape having a short direction along a front-rear direction and a longitudinal direction along a left-right direction,
the battery receptacle is disposed in the housing space, and
the battery pack is attached to the battery receptacle by being slid along the up-down direction relative to the battery receptacle.
